(19) United States
(12) Patent Application Publication
(10) Pub. No.: US 2003/0023584 A1
(43) Pub. Date: Jan. 30, 2003

(54) Universal information base system

(76) Inventor: Christopher Lockton Brandin, Colorado Springs, CO (US)

Correspondence Address: Dale B. Halling, Suite 311, 24 South Weber Street, Colorado Springs, CO, 80903, US

(21) Appl. No.: 10/134,030

(22) Filed: Apr. 26, 2002

Related U.S. Application Data
(60) Provisional application No. 60/287,074, filed on Apr. 27, 2001.

(51) Int. Cl. G06F 7/00

(52) U.S. Cl. 707/3

(57) ABSTRACT

A universal information base system has an associative information system. A structured data input system is coupled to the associative information system. A search and behavioral operations engine is coupled to the associative information system.

### RELATED APPLICATIONS

This patent claims priority on the provisional patent application entitled “NeoCore Knowledge Building Server Architecture”, serial No. 60/287,074, filed Apr. 27, 2001, assigned to the same assignee as the present application.

This patent application is related to the U.S. patent application Ser. No. 09/977,267, entitled “Method of Storing and Flattening a Structured Data Document” filed on Oct. 12, 2001, assigned to the same assignee as the present application and the U.S. patent application Ser. No. 09/977,266 entitled “System and Method for Implementing Behavioral Operations” filed on Oct. 12, 2001, assigned to the same assignee as the present application

### FIELD OF THE INVENTION

The present invention relates generally to the field of database management systems and structured data documents and more particularly to a universal information base system.

### BACKGROUND OF THE INVENTION

Database management systems require that data types (fields) be predefined before they can be used. As databases get large they require that indices of the data be maintained to provide reasonable response times to queries. Unfortunately, these indices must be predefined. Searches and other operations against a databases generally require that the operation be completed in a single pass. Finally there is no efficient way to retrieve context based on data.

Structured data documents such as HTML (Hyper Text Markup Language), XML (extensible Markup Language) and SGML (Standard Generalized Markup Language) documents and derivatives use tags to describe the data associated with the tags. This has an advantage over databases in that not all the fields are required to be predefined. XML is presently finding widespread interest for exchanging information between businesses. XML appears to provide an excellent solution for internet business to business applications. Unfortunately, XML documents require a lot of memory and therefore are time consuming and are generally more difficult to search than standard databases. There have been attempts to combine a standard database with XML documents. So far these attempts have traded one of the enumerated problems for another of the enumerated problems.

Thus there exists a need for a universal information base system.

### BRIEF DESCRIPTION OF THE DRAWINGS

FIG. 1 is an example of an XML document in accordance with one embodiment of the invention;

FIG. 2 is an example of a flattened data document in accordance with one embodiment of the invention;

FIG. 3 is a block diagram of a system for storing a flattened data document in accordance with one embodiment of the invention;

FIG. 4 shows two examples of a map store cell in accordance with one embodiment of the invention;

FIG. 5 is a flow chart of a method of storing a structured data document in accordance with one embodiment of the invention;

FIG. 6 is a flow chart of a method of storing a structured data document in accordance with one embodiment of the invention;

FIG. 7 is a flow chart of a method of storing a structured data document in accordance with one embodiment of the invention;

FIG. 8 is a block diagram of a system for storing a flattened structured data document in accordance with one embodiment of the invention;

FIG. 9 is a block diagram of a system for storing a flattened structured data document in accordance with one embodiment of the invention;

FIG. 10 is a flow chart of the steps used in a method of storing a flattened structured data document in accordance with one embodiment of the invention;

FIG. 11 is a flow chart of the steps used in a method of storing a flattened structured data document in accordance with one embodiment of the invention;

FIG. 12 is a schematic diagram of a method of storing a numerical document object model in accordance with one embodiment of the invention;

FIG. 13 shows several examples of search queries of a numerical document object model in accordance with one embodiment of the invention;

FIG. 14 is a flow chart of the steps used in a method of performing a search of a numerical document object model in accordance with one embodiment of the invention;

FIG. 15 is a flow chart of the steps used in a method of performing a search of a numerical document object model in accordance with one embodiment of the invention;

FIG. 16 is a flow chart of the steps used in a method of translating a structured data document in accordance with one embodiment of the invention;

FIG. 17 is a flow chart of the steps used in a method of creating an alias in a numerical document object model in accordance with one embodiment of the invention;

FIG. 18 is a flow chart of the steps used in a method of operating an XML database in accordance with one embodiment of the invention;

FIG. 19 is a block diagram of a system for operating an XML database in accordance with one embodiment of the invention;

FIGS. 20A, B, and C are a flow chart of the steps used in a method of performing a search of an XML database in accordance with one embodiment of the invention;

FIG. 21 is an example of a convergence search query in accordance with one embodiment of the invention; and

FIG. 22 is an example of an XML document in accordance with one embodiment of the invention;

FIG. 23 is an example of a flattened data document in accordance with one embodiment of the invention;

FIG. 24 is an example of a map index in accordance with one embodiment of the invention;

FIG. 25 is a flow chart of the steps used in a method of flattening a structured data document;

FIGS. 26 & 27 are a flow chart of the steps used in a method of storing a flattened data document;

FIG. 28 is a schematic diagram of a sliding window search routine in accordance with one embodiment of the invention;

FIGS. 29 & 30 are a flow chart of the steps used in performing a sliding window search in accordance with one embodiment of the invention;

FIGS. 31 & 32 are a flow chart of the steps used in performing a sliding window search in accordance with another embodiment of the invention;

FIG. 33 is a flow chart of the steps used in performing a sliding window search in accordance with another embodiment of the invention;

FIG. 34 is a flow chart of the steps used in an icon shift function in accordance with one embodiment of the invention;

FIG. 35 is a flow chart of the steps used in an icon unshift function in accordance with one embodiment of the invention;

FIG. 36 is a flow chart of the steps used in a transform function in accordance with one embodiment of the invention;

FIG. 37 is a flow chart of the steps used in an untransform function in accordance with one embodiment of the invention;

FIG. 38 is an example of a transform lookup table;

FIG. 39 is an example of a transform translation table;

FIG. 40 is a block diagram of a system for associative processing in accordance with one embodiment;

FIG. 41 is a linear feedback register used to calculate an icon (CRC, polynomial code) in accordance with one embodiment of the invention;

FIG. 42 is a block diagram of a system for associative processing in accordance with one embodiment;

FIG. 43 is a block diagram of a system for implementing behavioral operations in accordance with one embodiment of the invention;

FIG. 44 is a block diagram of a system for implementing behavioral operations in accordance with one embodiment of the invention;

FIG. 45 is an example of a behavioral operation;

FIG. 46 is a flow chart of the steps used in a method of behavioral operation of a data document in accordance with one embodiment of the invention; and

FIG. 47 is a flow chart of the steps used in a method of behavioral operation of a data document in accordance with one embodiment of the invention;

FIG. 48 is a block diagram of a universal information base system in accordance with one embodiment of the invention;

FIG. 49 is a block diagram of an associative information store in accordance with one embodiment of the invention; and

FIG. 50 is a block diagram of a data input system in accordance with one embodiment of the invention.

### DETAILED DESCRIPTION OF THE DRAWINGS

A universal information base system is a term coined for the system described herein. A universal information base system provides a number of advantages over a standard database management system or structured data document system. For instance, new data types (metadata) may be added or deleted at any time. Thus it is extensible like XML. The universal information base indexes almost all information in the store and therefore complex searches can be done quickly and efficiently. In addition, the indices do not have to be predefined. The universal information system allows multiple pass operations on the store and can accommodate layered searches. Context (metadata) may be acquired based on data using the system described herein. In addition, actions or behaviors may be automatically implemented using the universal information base system.

A universal information base system has an associative information system. A structured data input system is coupled to the associative information system. A search and behavioral operations engine is coupled to the associative information system.

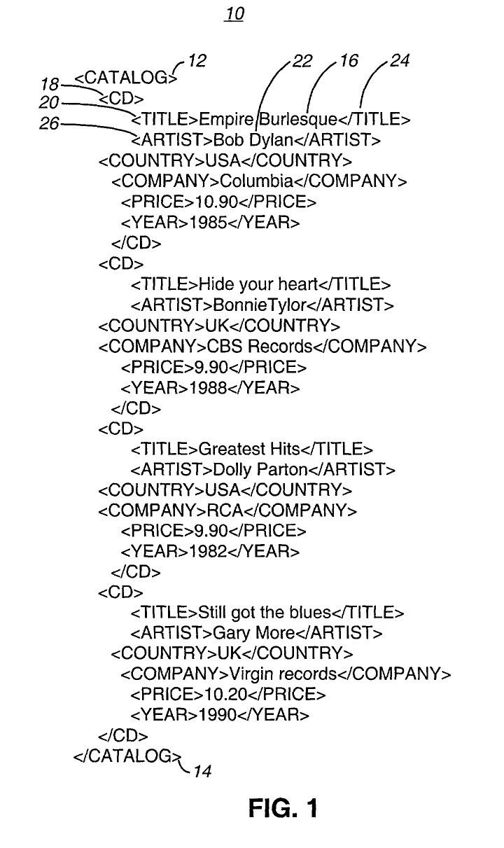

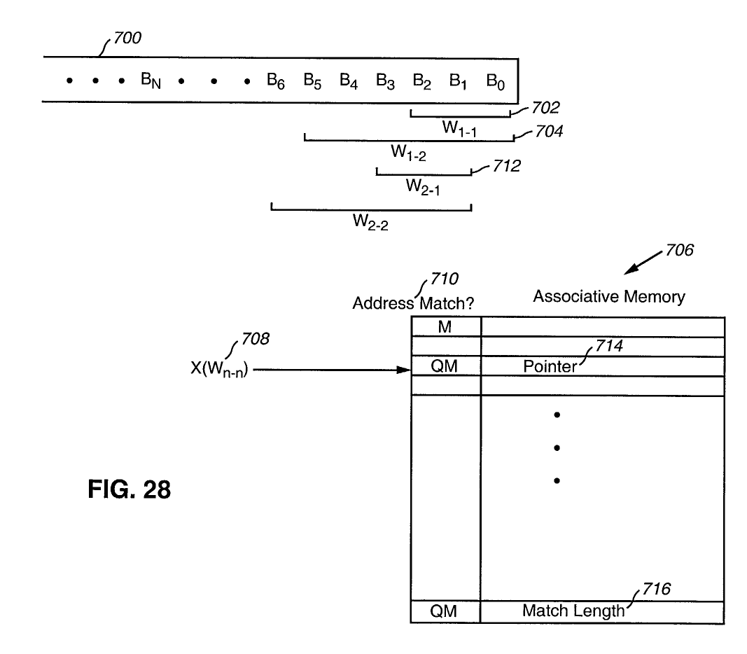

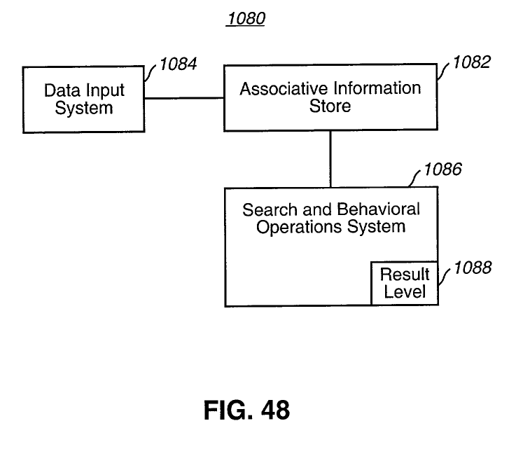

The universal information base system incorporates many new features not found in the literature. As a result, the definitions for the items described herein are important to understanding the invention. FIGS. 1-27 describe the way information is input and stored in the universal information system and how some searches are performed on the system. FIGS. 28-47 describe an advanced searching system and the combination of the advanced searching system with a behavioral system (engine). Behaviors are actions taken based on a particular pattern be matched. FIGS. 48-50 show how the input and stored information system is combined with the advanced search and behavioral system to form the universal information base system.

FIG. 1 is an example of an XML document 10 in accordance with one embodiment of the invention. The words between the < > are tags that describe the data. This document is a catalog 12. Note that all tags are opened and later closed. For instance <catalog> 12 is closed at the end of the document </catalog> 14. The first data item is “Empire Burlesque” 16. The tags <CD> 18 and <TITLE> 20 tell us that this is the title of the CD (Compact Disk). The next data entry is “Bob Dylan” 22, who is the artist. Other compact disks are described in the document.

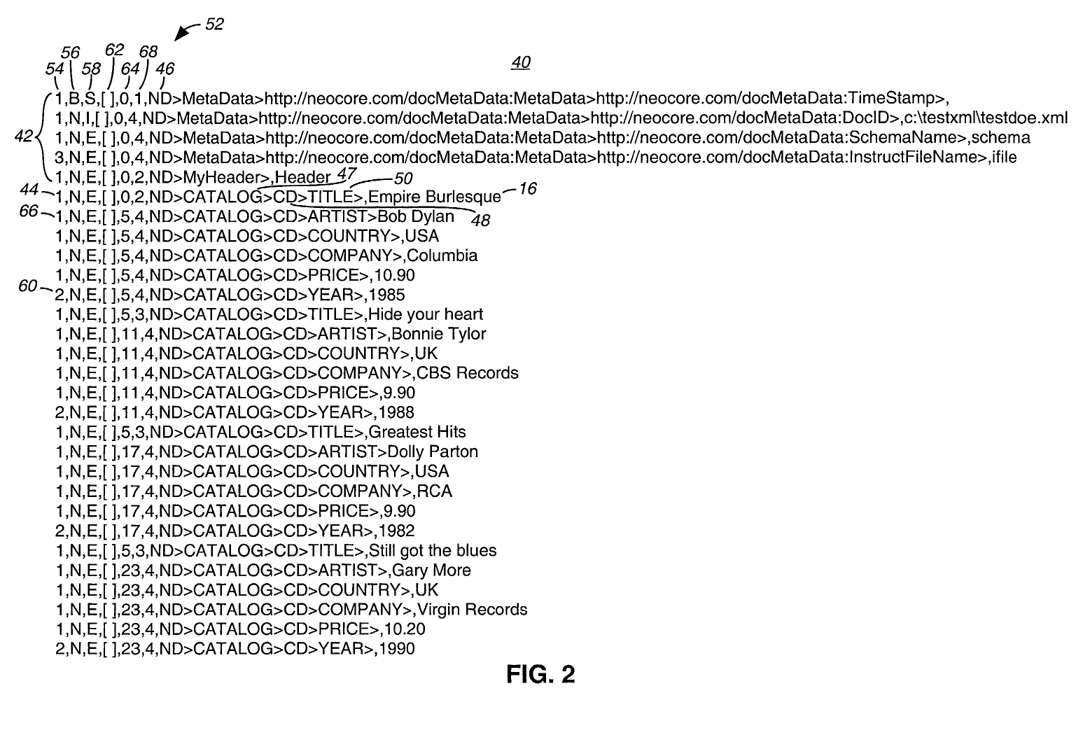

FIG. 2 is an example of a flattened data document (numerical document object model) 40 in accordance with one embodiment of the invention. The first five lines 42 are used to store parameters about the document. The next line (couplet) 44 shows a line that has flattened all the tags relating to the first data entry 16 of the XML document 10. Note that the tag <ND> 46 is added before every line but is not required by the invention. The next tag is CATALOG> 47 which is the same as in the XML document 10. Then the tag CD> 48 is shown and finally the tag TITLE> 50. Note this is the same order as the tags in the XML document 10. A plurality of formatting characters 52 are shown to the right of each line. The first column is the n-tag level 54. The n-tag defines the number of tags that closed in that line. Note that first line 44, which ends with the data entry “Empire Burlesque” 16, has a tag 24 (FIG. 1) that closes the tag TITLE. The next tag 26 opens the tag ARTIST. As a result the n-tag for line 44 is a one. Note that line 60 has an n-tag of two. This line corresponds to the data entry 1985 and both the YEAR and the CD tags are closed.

The next column 56 has a format character that defines whether the line is first (F) or another line follows it (N-next) or the line is the last (L). The next column contains a line type definition 58. Some of the line types are: time stamp (S); normal (E); identification (I); attribute (A); and processing (P). The next column 62 is a delete level and is enclosed in a parenthesis. When a delete command is received the data is not actually erased but is eliminated by entering a number in the parameters in a line to be erased. So for instance if a delete command is received for “Empire Burlesque” 16, a “1” would be entered into the parenthesis of line 44. If a delete command was received for “Empire Burlesque” 16 and <TITLE>, </TITLE>, a “2” would be entered into the parenthesis. This provides a very simple delete function for tags and data. The next column is the parent line 64 of the current line. Thus the parent line for the line 66 is the first line containing the tag CATALOG. If you count the lines you will see that this is line five (5) or the preceding line. The last column of formatting characters is a p-level 68. The p-level 68 is the first new tag opened but not closed. Thus at line 44, which corresponds to the data entry “Empire Burlesque” 16, the first new tag opened is CATALOG. In addition the tag CATALOG is not closed. Thus the p-level is two (2).

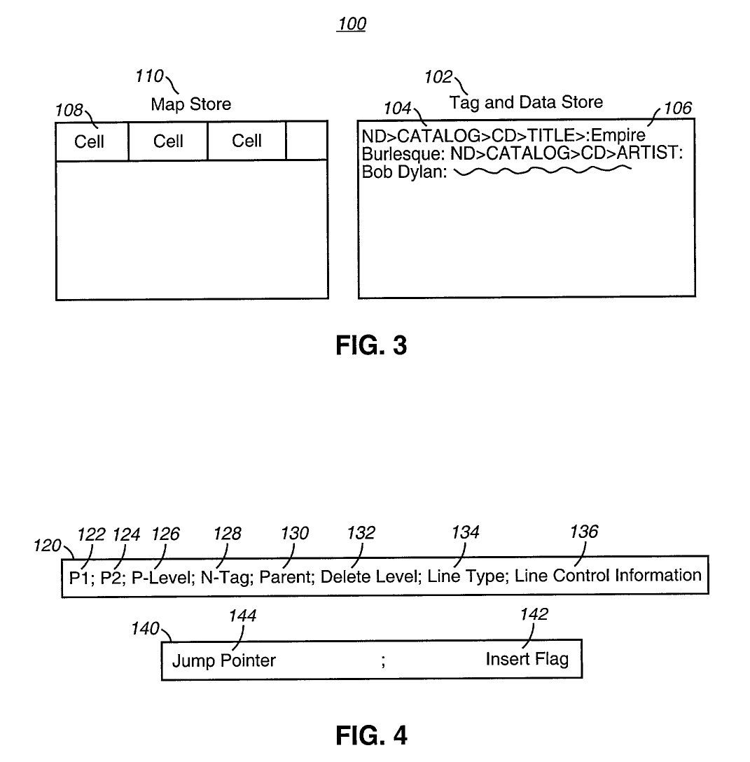

FIG. 3 is a block diagram of a system 100 for storing a flattened data document in accordance with one embodiment of the invention. Once the structured data document is flattened as shown in FIG. 2, it can be stored. Each unique tag or unique set of tags for each line is stored to a tag and data store 102. The first entry in the tag and data store is ND>CATALOG>CD>TITLE> 104. Next the data entry “Empire Burlesque” 106 is stored in the tag and data store 102. The pointers to the tag and data entry in the tag and data store 102 are substituted into line 44. Updated line 44 is then stored in a first cell 108 of the map store 110. In one embodiment the tag store and the data store are separate. The tag and data store 102 acts as a dictionary, which reduces the required memory size to store the structured data document. Note that the formatting characters allow the structured data document to be completely reconstructed.

FIG. 4 shows two examples of a map store cell in accordance with one embodiment of the invention. The first example 120 works as described above. The cell (couplet) 120 has a first pointer (P₁) 122 that points to the tag in the tag and data store 102 and a second pointer (P₂) 124 that points to the data entry. The other information is the same as in a flattened line such as: p-level 126; n-tag 128; parent 130; delete level 132; line type 134; and line control information 136. The second cell type 140 is for an insert. When an insert command is received a cell has to be moved. The moved cell is replaced with the insert cell 140. The insert cell has an insert flag 142 and a jump pointer 144. The moved cell and the inserted cell are at the jump pointer. Thus this provides a very simple insert function for data and tags.

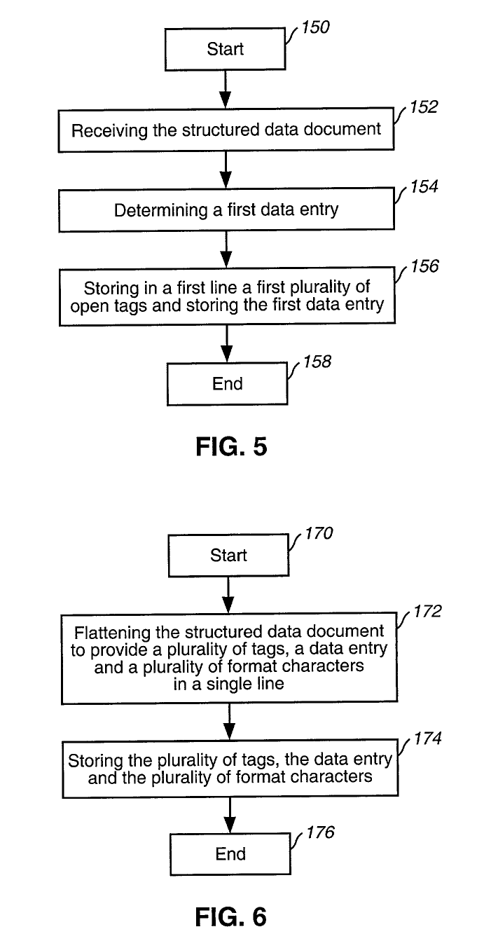

FIG. 5 is a flow chart of a method of storing a structured data document. The process starts, step 150, by receiving the structured data document at step 152. A first data entry is determined at step 154. In one embodiment, the first data entry is an empty data slot. At step 156 a first plurality of open tags and the first data entry is stored which ends the process at step 158. In one embodiment a level of a first opened tag is determined. The level of the first opened tag is stored. In another embodiment, a number of consecutive tags closed after the first data entry is determined. This number is then stored. A line number is stored.

In one embodiment, a next data entry is determined. A next plurality of open tags proceeding the next data entry is stored. These steps are repeated until a next data entry is not found. Note that the first data entry may be a null. A plurality of format characters associated with the next data entry are also stored. In one embodiment the flattened data document is expanded into the structured data document using the plurality of formatting characters.

FIG. 6 is a flow chart of a method of storing a structured data document. The process starts, step 170, by flattening the structured data document to a provide a plurality of tags, a data entry and a plurality of format characters in a single line at step 172. At step 174 the plurality of tags, the data entry and the plurality of format characters are stored which ends the process at step 176. In one embodiment, the plurality of tags are stored in a tag and data store. In addition, the plurality of format characters are stored in map store. The data entry is stored in the tag and data store. A first pointer in the map store points to the plurality of tags in the tag and data store. A second pointer is stored in the map store that points to the data store. In one embodiment, the structured data document is received. A first data entry is determined. A first plurality of open tags preceding the first data entry and the first data entry are placed in a first line. A next data entry is determined. A next plurality of open tags proceeding the next data entry is placed in the next line. These steps are repeated until a next data entry is not found. In one embodiment a format character is placed in the first line. In one embodiment the format character is a number that indicates a level of a first tag that was opened. In one embodiment the format character is a number that indicates a number of tags that are consecutively closed after the first data entry. In one embodiment the format character is a number that indicates a line number of a parent of a lowest level tag. In one embodiment the format character is a number that indicates a level of a first tag that was opened but not closed. In one embodiment the format character is a character that indicates a line type. In one embodiment the format character indicates a line control information. In one embodiment the structured data document is an extensible markup language document. In one embodiment the next data entry is placed in the next line.

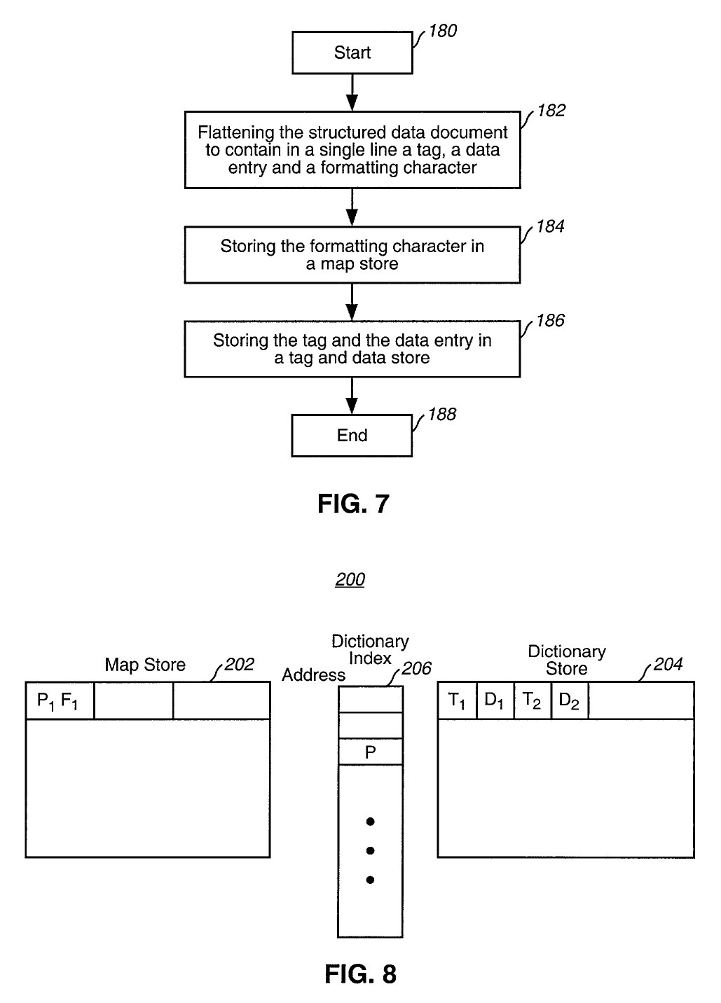

FIG. 7 is a flow chart of a method of storing a structured data document. The process starts, step 180, by flattening the structured data document to contain in a single line a tag, a data entry and a formatting character at step 182. The formatting character is stored in a map store at step 184. At step 186 the tag and the data entry are stored in a tag and data store which ends the process at step 188. In one embodiment a first pointer is stored in the map store that points to the tag in the tag and data store. A second pointer is stored in the map store that points to the data entry in the tag and data store. In one embodiment a cell is created in the map store for each of the plurality of lines in a flattened document. A request is received to delete one of the plurality of data entries. The cell associated with the one of the plurality of data entries is determined. A delete flag is set. Later a restore command is received. The delete flag is unset. In one embodiment, a request to delete one of a plurality of data entries and a plurality of related tags is received. A delete flag is set equal to the number of the plurality of related tags plus one. In one embodiment, a request is received to insert a new entry. A previous cell containing a proceeding data entry is found. The new entry is stored at an end of the map store. A contents of the next cell is moved after the new entry. An insert flag and a pointer to the new entry is stored in the next cell. A second insert flag and second pointer is stored after the contents of the next cell.

Thus there has been described a method of flattening a structured data document to form a numerical document object model (DOM). The process of flattening the structured data document generally reduces the number of lines used to describe the document. The flattened document is then stored using a dictionary to reduce the memory required to store repeats of tags and data. In addition, the dictionary (tag and data store) allows each cell in the map store to be a fixed length. The result is a compressed document that requires less memory to store and less bandwidth to transmit.

FIG. 8 is a block diagram of a system 200 for storing a flattened structured data document (numerical DOM) in accordance with one embodiment of the invention. The system 200 has a map store 202, a dictionary store 204 and a dictionary index 206. Note that this structure is similar to the system of FIG. 3. The dictionary store 204 has essentially the same function as the data and tag store (FIG. 3) 102. The difference is that a dictionary index 206 has been added. The dictionary index 206 is an associative index. An associative index transforms the item to be stored, such as a tag, tags or data entry, into an address. Note that in one embodiment the transform returns an address and a confirmer as explained in the U.S. Pat. No. 6,324,636, entitled “Memory Management System and Method” issued on Nov. 27, 2001, assigned to the same assignee as the present application and hereby incorporated by reference. The advantage of the dictionary index 206 is that when a tag or data entry is received for storage it can be easily determined if the tag or data entry is already stored in the dictionary store 204. If the tag or data entry is already in the dictionary store the offset in the dictionary can be immediately determined and returned for use as a pointer in the map store 202.

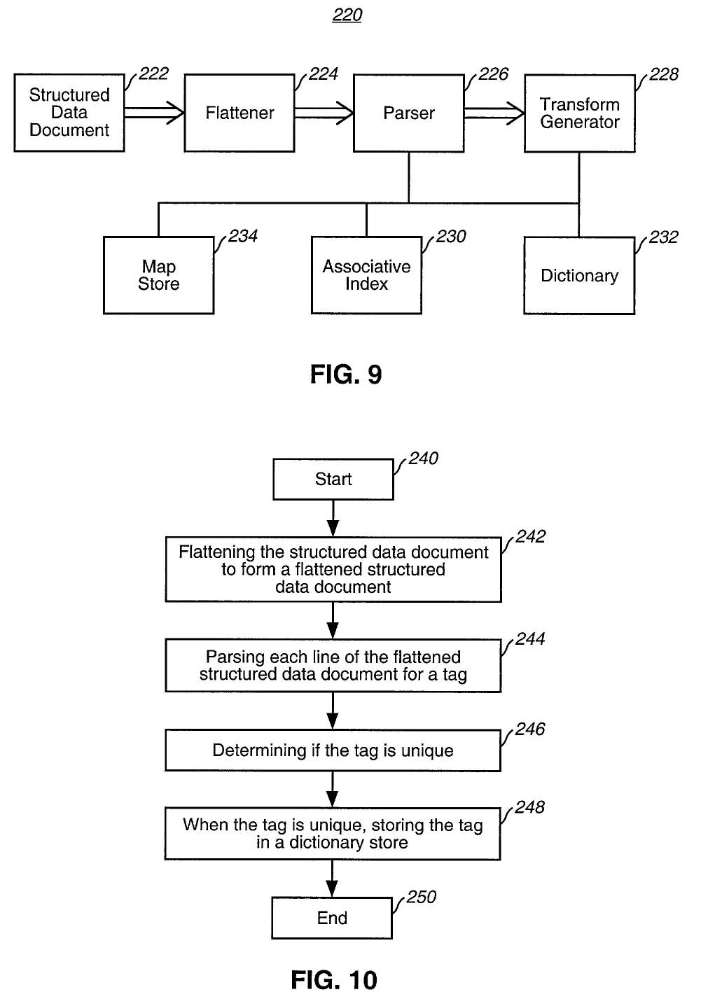

FIG. 9 is a block diagram of a system 220 for storing a flattened structured data document (numerical DOM) in accordance with one embodiment of the invention. A structured data document 222 is first processed by a flattener 224. The flattener 224 performs the functions described with respect to FIGS. 1 & 2 to form a numerical DOM. A parser 226 then determines the data entries and the associated tags. One of the data entries is transformed by the transform generator 228. This is used to determine if the data entry is in the associative index 230. When the data entry is not in the associative index 230, it is stored in the dictionary 232. A pointer to the data in the dictionary is stored at the appropriate address in the associative index 230. The pointer is also stored in a cell of the map store 234 as part of a flattened line.

FIG. 10 is a flow chart of the steps used in a method of storing a flattened structured data document (numerical DOM) in accordance with one embodiment of the invention. The process starts, step 240, by flattening the structured data document to form a flattened structured data document (numerical DOM) at step 242. Each line of the flattened structured data document is parsed for a tag at step 244. Next it is determined if the tag is unique at step 246. When the tag is unique, step 248, the tag is stored in a dictionary store which ends the process at step 250. In one embodiment a tag dictionary offset is stored in the map store. A plurality of format characters are stored in the map store. When a tag is not unique, a tag dictionary offset is determined. The tag dictionary offset is stored in the map store. The way the document is stored allows unique tags (new tags) to be stored (created) as part of the normal storage processes. This is a significant advantage of database management systems.

In one embodiment, the tag is transformed to form a tag transform. An associative lookup is performed in a dictionary index using the tag transform. A map index is created that has a map pointer that points to a location in the map store of the tag. The map pointer is stored at an address of the map index that is associated with the tag transform.

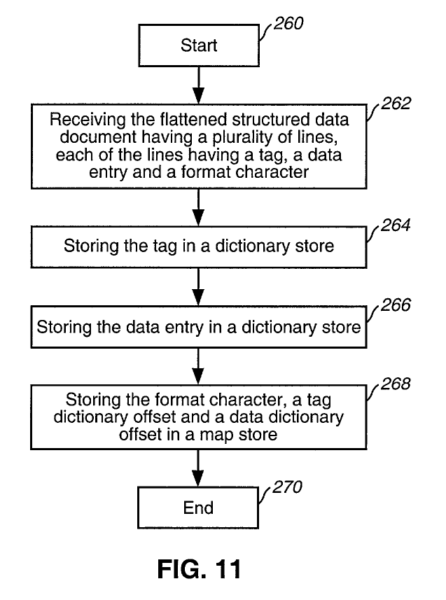

FIG. 11 is a flow chart of the steps used in a method of storing a flattened structured data document (numerical DOM) in accordance with one embodiment of the invention. The process starts, step 260, by receiving the flattened structured data document (numerical DOM) that has a plurality of lines (couplets) at step 262. Each of the plurality of lines contains a tag, a data entry and a format character. The tag is stored in a dictionary store at step 264. The data entry is stored in the dictionary store at step 266. At step 268 the format character, a tag dictionary offset and a data dictionary offset are stored in a map store which ends the process at step 270. In one embodiment, the tag is transformed to form a tag transform. The tag dictionary offset is stored in a dictionary index at an address pointed to by the tag transform. In one embodiment, it is determined if the tag is unique. When the tag is unique, the tag is stored in the dictionary store otherwise the tag is not stored (again) in the dictionary store. To determine if the tag is unique, it is determined if a tag pointer is stored in the dictionary index at an address pointed to by the tag transform.

In one embodiment, the data entry is transformed to form a data transform. The data dictionary offset is stored in the dictionary index at an address pointed to by the data transform. In one embodiment each of the flattened lines has a plurality of tags.

In one embodiment, a map index is created. Next it is determined if the tag is unique. When the tag is unique, a pointer to a map location of the tag is stored in the map index. When the tag is not unique, it is determined if a duplicates flag is set. When the duplicates flag is set, a duplicates count is incremented. When the duplicates flag is not set, the duplicates flag is set. The duplicates count is set to two. In one embodiment a transform of the tag with an instance count is calculated to form a first instance tag transform and a second instance tag transform. A first map pointer is stored in the map index at an address associated with the first instance transform. A second map pointer is stored in the map index at an address associated with the second instance transform.

In one embodiment a transform of the tag with an instances count equal to the duplicates count is calculated to form a next instance tag transform. A next map pointer is stored in the map index at an address associated with the next instance transform.

In one embodiment, a map index is created. Next it is determined if the data entry is unique. When the data entry is unique, a pointer to a map location of the tag is stored.

Note that this system allows multiple documents to be stored in a single map store. When there is a common tag between the two documents, such as company, the two documents can be searched or acted upon as if it were a single document. As will be apparent to those skilled in the art multiple documents may be combined in this manner. In addition, the map store may contain heterogeneous information sets. For instance, the map store may contain one document with phone book listings, another document with audio recordings, another document with patients' blood types. In fact, the system will work perfectly, if the type of information varied for each record.

Thus there has been described an efficient manner of storing a structured data document that requires significantly less memory than conventional techniques. The associative indexes significantly reduces the overhead required by the dictionary.

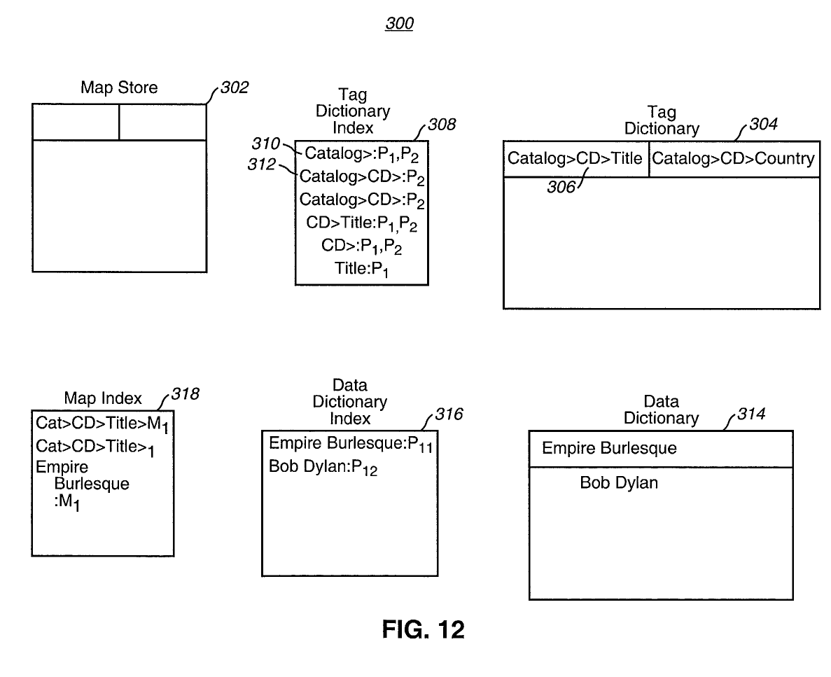

FIG. 12 is a schematic diagram of a method of storing a numerical document object model in accordance with one embodiment of the invention. This is similar to the models described with respect to FIGS. 3 & 8. The couplets (flattened lines) are stored in the map store 302. A tag dictionary 304 stores a copy of each unique tag string. For instance, the tag string CATALOG>CD>TITLE> 306 from line 44 (see FIG. 2) is stored in the tag dictionary 304. Note that the tag ND> is associated with every line and therefor has been ignored for this discussion. A tag dictionary index 308 is created. Every tag, incomplete tag string and complete tag string is indexed, in one embodiment. As a result the tag CATALOG> 310, CATALOG>CD> 312 and every other permutation is stored in the tag index 308, in one embodiment. Since a tag may occur in multiple entries it may have a number of pointers associated with the tag in the index.

A data dictionary 314 stores a copy of each unique data entry such as “Bob Dylan”. A data dictionary index 316 associates each data entry with its location in the dictionary. In one embodiment, the tag dictionary index and the data dictionary index are associative memories. Thus a mathematical transformation of the entry such as “Bob Dylan” provides the address in the index where a pointer to the entry is stored. In addition to the tag and data indices a map index 318 is created. The map index 318 contains an entry for every complete tag string (see string 306) and the complete tag string and associated data entry. Note that the map index may be an associative index. By creating these indices and dictionaries it is possible to quickly and efficiently search a structured data document. In addition, once the document is in this form it is possible to search for a data entry without ever having to look at the original document.

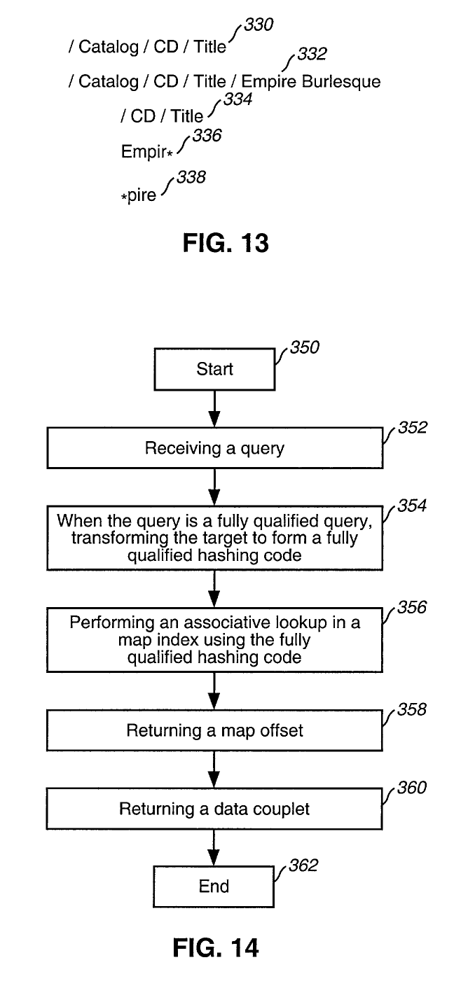

FIG. 13 shows several examples of search queries of a numerical document object model in accordance with one embodiment of the invention. The first example 330 is a fully qualified query since a complete tag string has been specified. The second example 332 is also a fully qualified query since a complete tag string and a complete data entry have been specified. The third example is a not fully qualified query since a partially complete tag string has been specified. The fourth 336 and fifth 338 examples are also examples of a not fully qualified query since the data entry is not complete. Note that the * stands for any wild card. If the data entry were completely specified, the query would be fully qualified.

FIG. 14 is a flow chart of the steps used in a method of performing a search of a numerical document object model in accordance with one embodiment of the invention. The process starts, step 350, by receiving a query at step 352. When the query is a fully qualified query, the target is transformed to form a fully qualified hashing code at step 354. Note the phrase “fully qualified hashing code” means the hashing code for the target of a fully qualified query. In one embodiment the hashing code is a mathematical transformation of the target to produce an address and a confirmer as explained in the U.S. Pat. No. 6,324,636, entitled “Memory Management System and Method” issued on Nov. 27, 2001, assigned to the same assignee as the present application and hereby incorporated by reference. An associative lookup in a map index is performed using the fully qualified at step 356. At step 358, a map offset is returned. At step 360, a data couplet is returned which ends the process at step 362. In one embodiment, an identified couplet of the numerical DOM (as stored in the map) is converted into an XML string. When the query is partially qualified, the target is transformed to form a partially qualified query. An associative lookup is performed in a dictionary index using the partially qualified query. A partially qualified query is one that does not contain a complete tag or data string, i.e, <TITLE> instead of ND>CATALOG>CD>TITLE>. A dictionary offset is returned. The complete string is located in the dictionary, using the dictionary offset. A pointer is located in a map index using the complete string. The complete reference is located in the numerical DOM using the pointer. The data couplet is converted into a data XML string.

In one embodiment, a result level is specified. The result level tells the system what level of detail to return to the user based on the search result. The result level may specify a couplet (tag & data), line, record, part of a document, the whole document or multiple documents.

In another embodiment, when the query includes a wildcard target, the dictionary is scanned for the wildcard target. A complete string is returned from the dictionary that contains the wildcard target. A pointer is located in a map index using the complete string. A couplet is located in the numerical DOM using the pointer.

In one embodiment the hashing code is determined using linear feedback shift register operation, such as (but not limited to) a cyclical redundancy code. In another embodiment, the hashing code is determined by using a modulo two polynomial division. In one embodiment, the divisor polynomial is an irreducible polynomial. Other hashing codes may also be used.

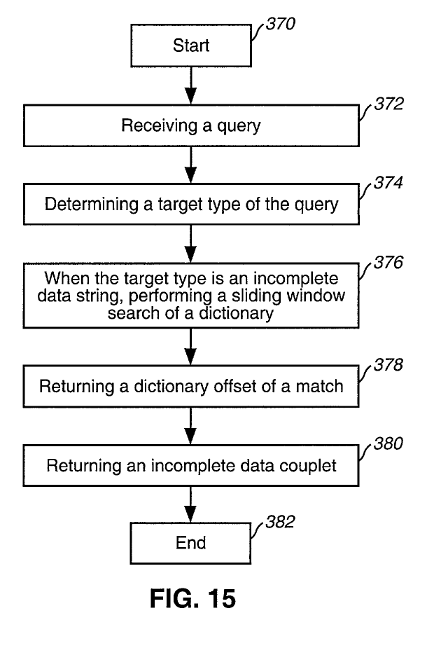

FIG. 15 is a flow chart of the steps used in a method of performing a search of a numerical document object model in accordance with one embodiment of the invention. The process starts, step 370, by receiving a query at step 372. A target type of the query is determined at step 374. When the target type is an incomplete data string, a sliding window search of a dictionary is performed at step 376. An incomplete data string could be <Bob> instead of <Bob Dylan>. A dictionary offset of a match is returned at step 378. In one embodiment a plurality of dictionary offsets are returned. At step 380 an incomplete data couplet is returned which ends the process at step 382. When the target type is an incomplete tag and a complete data string, the incomplete tag is transformed to form an incomplete target. An associative lookup in a map index is performed using the incomplete tag. At least one map offset is returned. The complete data string is transformed to form a complete data string. An associative lookup is performed in the map index. A data string map offset is returned. Next, the at least one map offset is compared with the data string map offset.

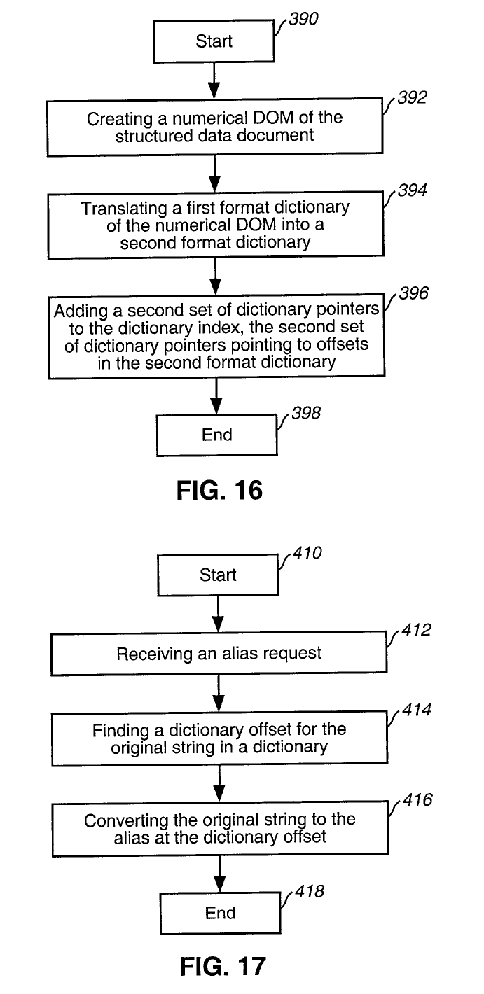

FIG. 16 is a flow chart of the steps used in a method of translating a structured data document in accordance with one embodiment of the invention. The process starts, step 390, by creating a numerical DOM of the structured data document at step 392. A first format dictionary is translated into a second format dictionary at step 394. At step 396 a second set of dictionary pointers are added to the dictionary index. The second set of dictionary pointers point to the offsets in the second format dictionary which ends the process at step 398. In one embodiment, a plurality of dictionary offset pointers are converted to a plurality of dictionary index pointers. This converts the map so it points to the dictionary index rather than the offsets into the dictionary, since there are two dictionaries now.

FIG. 17 is a flow chart of the steps used in a method of creating an alias in a numerical document object model in accordance with one embodiment of the invention. The process starts, step 410, by receiving an alias request at step 412. A dictionary offset for the original string in a dictionary is found at step 414. At step 416 the original string is converted to the alias at the dictionary offset which ends the process at step 418. An alias index is created that associates the alias and the original string or the dictionary offset of the original string, and in one embodiment the creation of the alias index includes creating an array that matches the dictionary offset to the original string. In another embodiment, the original string is transformed to form a string. An associative lookup in the dictionary is performed to find the dictionary offset.

A method of performing a search of a numerical document object model begins when the system receives a query. The query is transformed to form a fully qualified query. An associative lookup is performed in a map index using the fully qualified query. Finally, a map offset is returned. In one embodiment, an identified couplet of the numerical DOM is converted into an XML string. In another embodiment, it is determined if the target is a complete data string. When the target is a complete data string, the complete data string is transformed to form a complete query. An associative lookup is performed in a dictionary index using the complete data query. A dictionary offset is returned. The numerical DOM is scanned for the dictionary offset, and a data couplet is returned. The user may specify some other part of the document be returned as result of the query. In another embodiment the data couplet is converted into a data XML string. In another embodiment, the system determines if the target is a wildcard data string. When the target is the wildcard data string, performing a sliding window search of a dictionary. The system returns a dictionary offset of a match and scans the numerical DOM for the dictionary offset. An incomplete data couplet is returned.

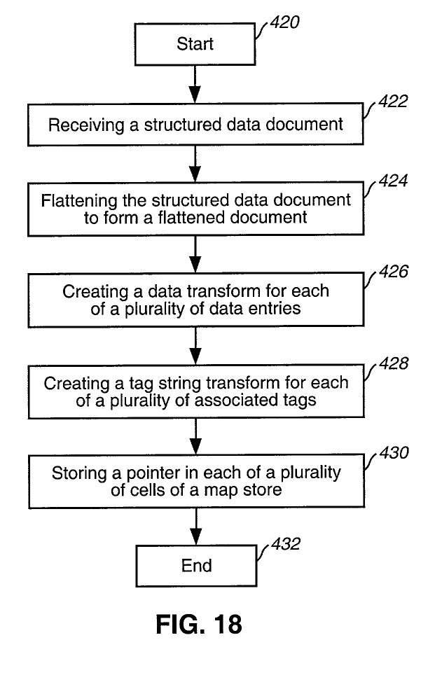

FIG. 18 is a flow chart of the steps used in a method of operating an XML database in accordance with one embodiment of the invention. The process starts, step 420, by receiving a structured data document at step 422. The structured data document is flattened to form a flattened document at step 424. At step 426 a data transform is created for each of a plurality of data entries. A tag string transform is created for each of a plurality of associated tags at step 428. At step 430 a pointer is stored in each of a plurality of cells of a map store which ends the process at step 432.

In one embodiment, a plurality of data entries and a plurality of tag entries are determined when the document is flattened. In another embodiment, the system stores a copy of each unique data entry in a data dictionary and then correlates the data transform to a data dictionary pointer in an associative data dictionary index. In another embodiment, first and second data dictionaries are created. The first and second data dictionaries are used to store first and second language copies of each unique data entry, respectively. The languages may be a computer-oriented format, such as ASCII or rich text, or the languages may be human, such as English or French. The data transform is correlated to a pair of dictionary pointers in the associative data dictionary index. A copy of each unique tag string is stored in a tag dictionary and the tag string transform is correlated to a tag dictionary pointer in an associative tag dictionary index. In another embodiment, first and second tag dictionaries are created. The first and second tag dictionaries are used to store first and second language copies of each unique tag entry, respectively. The tag transform is correlated to a pair of dictionary pointers in the associative tag dictionary index. Next an original entry and an alias entry are cross-referenced in an alias index.

In another embodiment, the system receives a search query. It is determined whether the search query contains a fully qualified target. When the search query does contain the fully qualified target, the fully qualified target is transformed to form a fully qualified transform. Next, a target pointer is received from the associative map index using the fully qualified transform, and the data couplet pointed to by the target pointer is read.

In another embodiment, the search query does not contain the fully qualified target. The partially qualified target is transformed to form a partially qualified transform. The system performs an associative lookup in the associative tag dictionary index using the partially qualified transform. The system returns a tag dictionary offset for the partially qualified transform, and a complete tag string is located in the tag dictionary. Next, the system receives a target pointer for the partially qualified transform, and the system reads the data couplet pointed to by the target pointer.

In another embodiment, the system receives an alias command containing an original element and an alias element, and an alias pointer is stored in an address of the alias index that is associated with the original entry. The alias element is transformed to form an alias transform and it is determined if the alias pointer is associated with the alias transform in the data dictionary index or the associative tag dictionary index. When the alias pointer is not associated with the alias transform, the alias element is stored in either the data dictionary or the tag dictionary and the alias pointer is returned. When the alias pointer is associated with the alias transform, the alias pointer is returned.

In another embodiment, the system receives a print command requesting a portion of the structured data document be printed in the second language. The system retrieves a first couplet from the portion of the map store and expands the first couplet using the second language data dictionary and the second language tag dictionary.

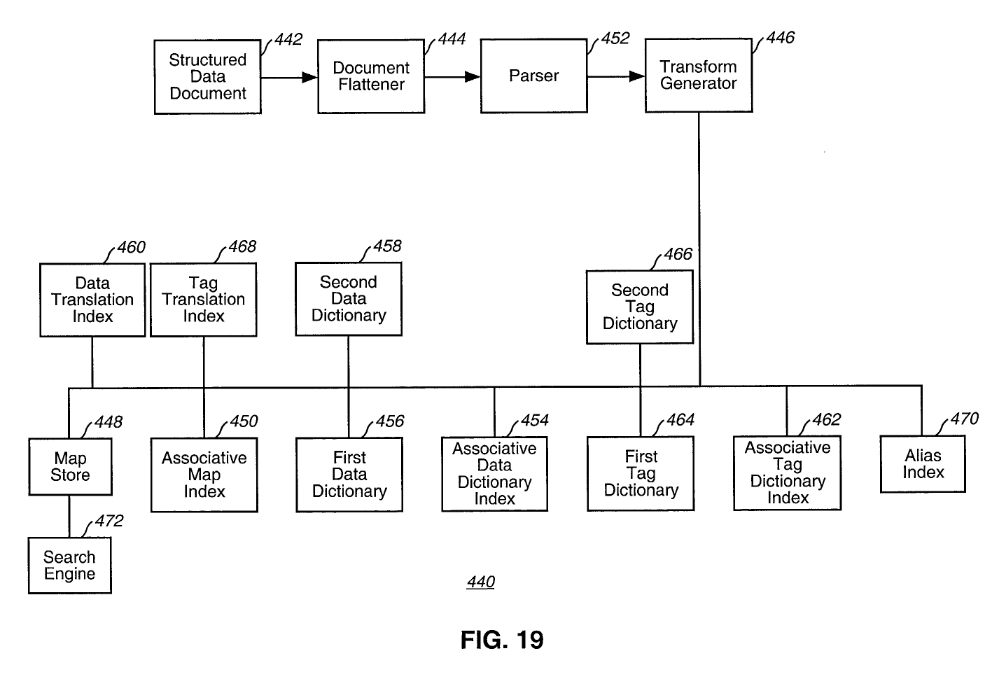

FIG. 19 is a block diagram of a system 440 for operating an XML and derivatives database in accordance with one embodiment of the invention. The system 440 receives a structured data document 442 at the document flattener 444. The document flattener 444 sends the flattened document to the transform generator 446, which creates a data transform for each of a plurality of data entries and a tag string transform for a plurality of associated tags. A map store 448 is connected to the transform generator and has a plurality of cells, each containing the data transform, the tag string transform and a format character. An associative map index 450 has a plurality of map addresses, each of the plurality of addresses having a pointer to the map store 448.

In one embodiment, the parser 452 receives the flattened document from the document flattener 444 and determines the plurality of data entries and the plurality of associated tags. In another embodiment, a data dictionary stores a copy of each unique data entry, and an associative data dictionary index 454 has a plurality of data addresses that correlates the data transform to a dictionary pointer.

In another embodiment, the data dictionary includes a first data dictionary 456 and a second data dictionary 458. The second data dictionary 458 stores the copy of each unique data entry in a second format. A data translation index 460 points to the first data dictionary 456 or the second data dictionary 458.

In another embodiment, a tag dictionary stores a copy of each unique tag string, and an associative tag dictionary index 462 has a plurality of tag addresses that correlates the tag string transform to a tag dictionary pointer. The tag dictionary includes a first tag dictionary 464 and a second tag dictionary 466, and the second tag dictionary 466 stores the copy of each unique tag string in a second format. A tag translation index 468 points to the first tag dictionary 464 or the second tag dictionary 466.

In another embodiment, an alias index 470 cross-references an original entry and an alias entry, and a search engine 472 is connected to the map store 448.

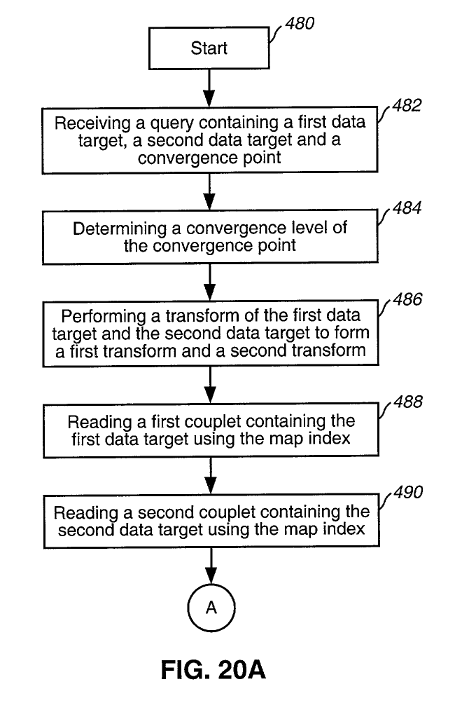

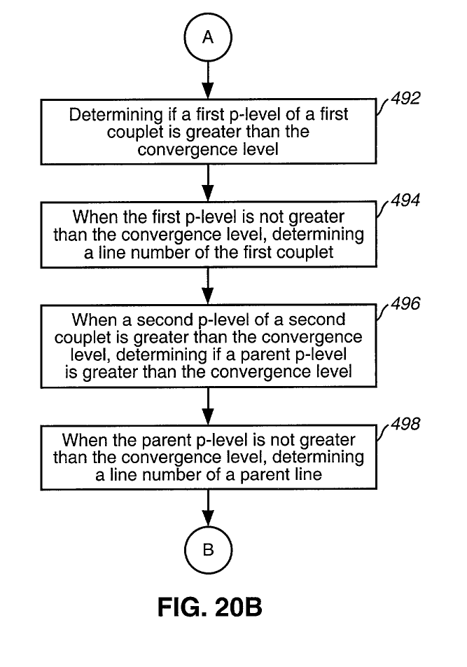

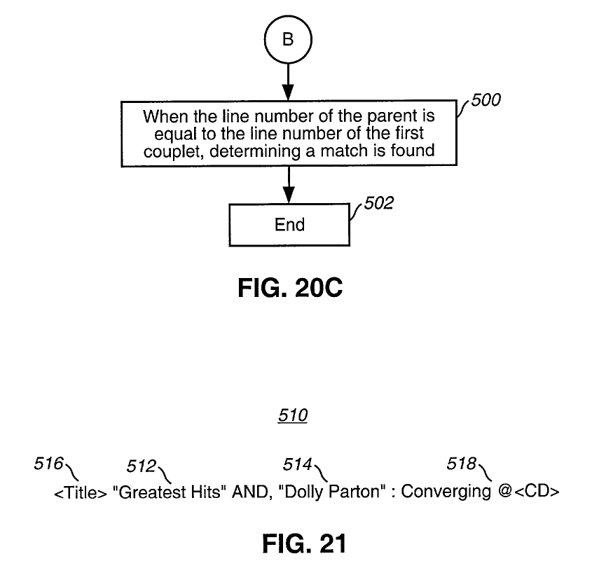

FIGS. 20A, B, and C are a flow chart of the steps used in a method of performing a search of an XML database in accordance with one embodiment of the invention. The process starts, step 480, when the system receives a query containing a first data target, a second data target and a convergence point at step 482. At step 484 the system determines a convergence level of the convergence point. The system performs a transform of the first data target and the second data target to form a first transform and a second transform at step 486, and at step 488 reads a first couplet containing the first data target using the map index. At step 490 the system reads a second couplet containing the second data target using the map index, and at step 492 it determines if a first p-level of a first couplet is greater than the convergence level, and when the first p-level is not greater than the convergence level, the system determines a line number for the first couplet at step 494. At step 496, when a second p-level of a second couplet is greater than the convergence level, the system determines if a parent p-level is greater than the convergence level, and when the parent p-level is not greater than the convergence level, the system determines a line number of a parent line at step 498. At step 500, when the line number of the parent is equal to the line number of the first couplet, the system determines if a match is found, which ends the process at step 502.

In one embodiment, when the line number of the parent is not equal to the line number of the first couplet, the system determines that the match is not found. In another embodiment, when the first p-level is greater than the convergence level, scanning the successive parents to find a parent line with a parent p-level not greater than the convergence level. Next, the system determines is the line number of the parent line of the second couplet is equal to a line number of the parent line of the first couplet, and when the line numbers are equal, the system determines that a match had been found.

FIG. 21 is an example of a search query 510 in accordance with one embodiment of the invention. The search query 510 is searching for “Greatest Hits” 512 and “Dolly Parton” 514 converging at the tag <cd>. The first data entry “Greatest Hits” 512 has a <Title> tag entry 516. The second data entry “Dolly Parton” 514 is partially qualified because it has no tag entry. Referring back to FIG. 2, <cd> is a level 3 tag, and the first and second data entries are found in lines 17 and 18 respectively. Starting with the “Greatest Hits” search parameter on line 17, if the p-level of the line where the search term is located is not greater than the convergence level, the system ceases searching. For line 17, the p-level is 3 and the convergence level is 3, so line converges on itself. Next, the system searches for the second search query term, “Dolly Parton.” “Dolly Parton” is found at line 18. The system compares the p-level of line 18, in this instance 4, to the convergence level of the query, in this instance 3. The p-level of line 18 is 4, which is greater than the convergence level, 3. The system moves up to line 18's parent and determines the parent line's p-level. The parent line of line 18 is line 17, in this case. The p-level of the parent line, line 17 is 3, is not greater than the convergence level, 3. Next, the system compares the parent line's line number, 17, to the line number of the first query term, 17. Convergence occurs when these two line numbers are the same. Thus the convergence of “Greatest Hits” and “Dolly Parton” occurs under the tag <cd> at line 17.

Thus there has been described a method of operating an extensible markup language database that is significantly more efficient.

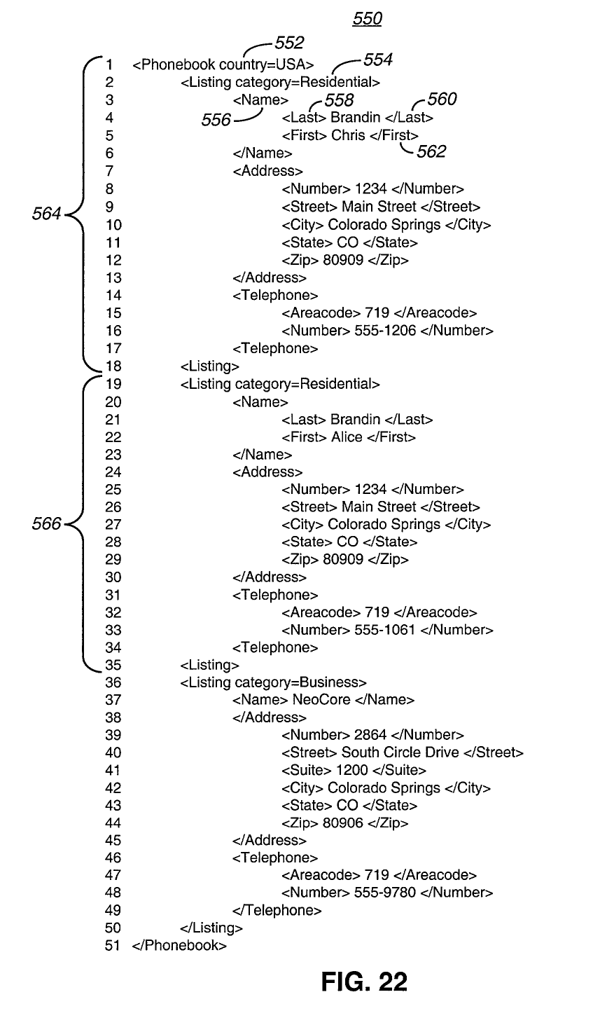

FIG. 22 is an example of an XML document 550 in accordance with one embodiment of the invention. The XML document includes attributes 552, 554, open tags 556, 558 and closed tags 560, 562. A first record 564 in the XML document 550 includes lines 1-18. A second record 566 includes lines 1 & 19-35. Line 1 is included because it is an attribute that applies to all the records below (and inside) of the attribute. The attribute 552 is a pushed attribute on the second record.

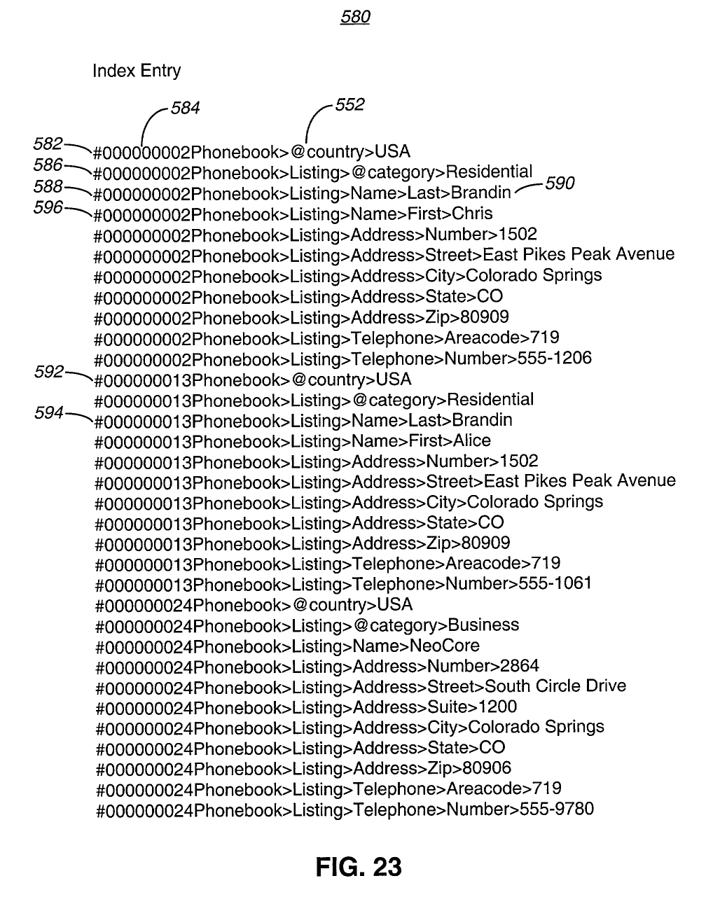

FIG. 23 is an example of a flattened data document 580 in accordance with one embodiment of the invention. The flattened data document 580 is an example of how the XML document 550 may be flattened. The first line 582 of the flattened document 580 includes the attribute 552 and a record indicator 584. The second line 586 contains the attribute 554 (category=Residential) and the open tag “Phonebook”. The third line 588 contains all the open tags before the first data element “Brandin” 590. Note that the first line 592 of the next record contains the pushed attribute (country=USA) 552. All lines contain a record indicator 584 and this is helpful in converging a search. For instance, assume we had a query for “last name=Brandin and First Name=Chris”. The first target (last name=Brandin) has two hits, line 588 and line 594. The second target has one hit line 596. Since the record indicator for lines 588 and 596 are “000000002”, then the search converges on the record “0000002” and that record is returned to the user. The other line 594 has record indicator “000000013”. Note that the flattened document might also include the formatting information in FIG. 2.

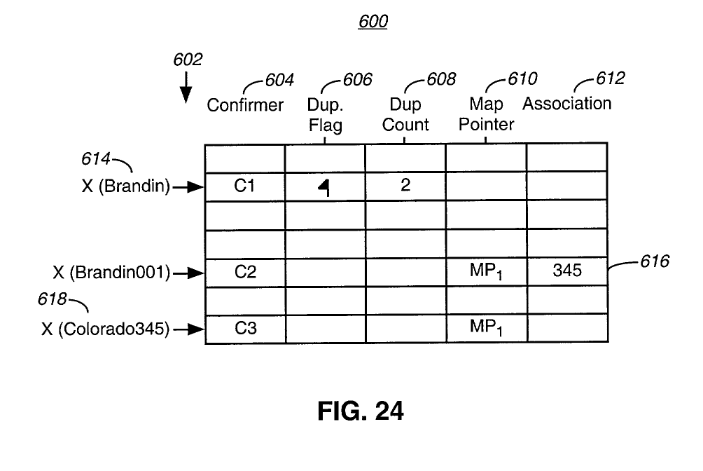

FIG. 24 is an example of a map index 600 in accordance with one embodiment of the invention. In one embodiment the map index is an associative memory such as the memory shown in U.S. Pat. No. 6,324,636, entitled “Memory Management System and Method” issued on Nov. 27, 2001, assigned to the same assignee as the present application and hereby incorporated by reference. The map index 600 has an address 602, a confirmer 604, a duplicate flag 606, a duplicate count 608, a map pointer 610 and an association 612. The address for an item, such as a data entry, to be indexed is found by transforming the data element. The confirmer 604 is part of the transform the other part is the address. The confirmer 604 is used to differentiate collisions between distinct items. The duplicate flag 606 is used to indicate a true duplicate exists. A duplicate count 608 keeps a count of the number of duplicates. The map pointer 610 points to the location where the item can be found in the map store. The association 612 is used to find a quick intersection between targets (items) that have multiple entries. Assume a query of “last name Brandin and state=Colorado”. There would be thousands of entries for the target Colorado, but a significantly more limited number of people with the last name Brandin. By transforming “Brandin” 614 we find there are two duplicates. Next we transform “Brandin001”, where “001” is the instance count. This points to an address 616 having an association 612 (345). The transform of “Colorado 345” 618 is determined. Since there is a confirmer C3, at this address and the map pointer (MP1) is the same we know it is part of the same record. If an entry has not been found then we would have looked at the second instance of Brandin and repeated the steps to see if there was a convergence.

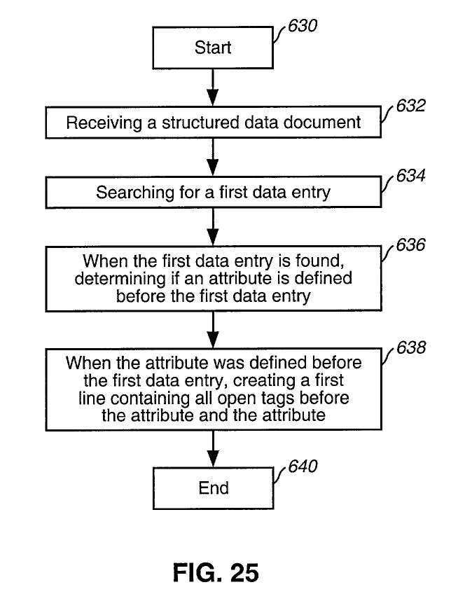

FIG. 25 is a flow chart of the steps used in a method of flattening a structured data document. The process starts, step 630. by receiving a structured data document at step 632. The first data entry is searched for by the system at step 634. When the first data entry is found, it is determined if an attribute is defined before the first data entry at step 636. When the attribute was defined before the first data entry at step 638, a first line is created containing all open tags before the attribute and the attribute which ends the process at step 640. In one embodiment it is next determined if a second attribute is defined before the first data entry. When the second attribute is not defined before the first data entry, another line is creating containing a set of open tags up to the first data entry.

In one embodiment, a record is defined for the structured data document. The record indicator and the data entry are added to the another line. A next data entry is searched for by the system next. When the next data entry is found, it is determined if the next data entry is in a different record than the first data entry. When the next data entry is in the different record, a next line containing all open tags before the attribute and the attribute is created. Then all open tags preceding the next data entry are stored in a line after the next line. The next data entry and a record indicator are also stored. This process is repeated to form a flattened document.

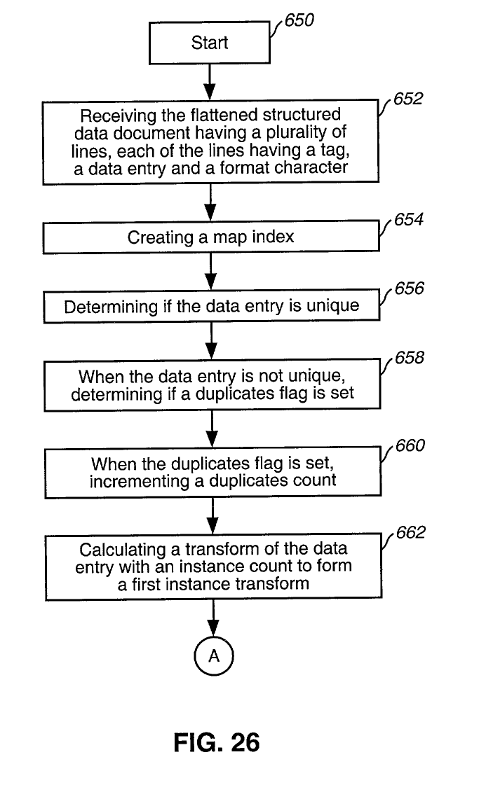

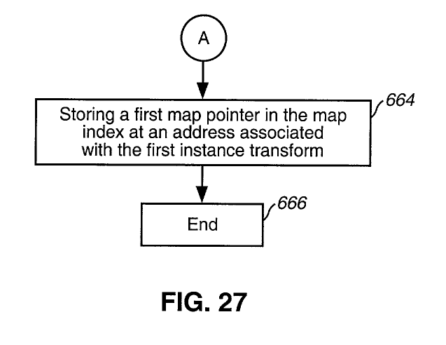

FIGS. 26 & 27 are a flow chart of the steps used in a method of storing a flattened data document. The process starts, at step 650, by receiving the flattened structured data document having a plurality of lines, each of the lines having a tag, a data entry and a format character at step 652. A map index is created at step 654. Next it is determined if the data entry is unique at step 656. When the data entry is not unique, determining if a duplicates flag is set at step 658. When the duplicates flag is set, a duplicates count is incremented at step 660. A transform of the data entry with the instance count is calculated to form a first instance transform at step 662. At step 664 a first map pointer is stored in the map index at an address associated with the first instance transform which ends the process at step 666. Note the transform can be a CRC (cyclical redundancy code) or polynomial code. In one embodiment an association is stored at the address in the map index. A transform is calculated of the second data entry with the association to form a first associated data entry. A query having two targets is received. Next it is determined if a first target has fewer entries than the second target. When the first target has fewer entries than the second target, a first instance of the first target is looked up to find a first association. The second target with the association is transformed to form a second target association. When the entry for the second target is found, it is determined that a match has been found. When the second target is not found, a second instance of the first target is looked up to find a second association. The steps are repeated with the second association.

Thus there has been described a method of flattening a structured data document and storing the resulting flattened data document. The methods decrease the amount of memory necessary to store the information in the structured data documents and significantly reduce the time to search the document.

FIG. 28 is a schematic diagram of a sliding window search routine in accordance with one embodiment of the invention. A data block 700 to be searched is represented as B₀, B₁, B₂-Bₙ, where B₀ may represented a byte of data. A first window 702 (W₁₋₁) has a search window size of three bytes. The search window size, in one embodiment, is equal to the size of one of the plurality of data strings for which we are searching. Another window 704 (W₂₋₁) has a search window size of five bytes. An associative database (associative memory) 706 consists of a plurality of address {X(Wₙ₋ₙ)} 708. In one embodiment, the transform of each of the plurality of data strings corresponds to one of the addresses 708 of the associative memory 706. In another embodiment, a transform for at least a first portion of each of the plurality of data strings corresponds to one of the addresses 708 of the associative memory 706. In one embodiment., the transform is a cyclical redundancy code for the plurality of data strings or first portion of the plurality of data strings. In another embodiment, the transform is any linear feedback shift register transformation (polynomial code) of the data string. Generally the polynomial code is selected to have as few collisions as possible.

In one embodiment, a transform (icon) is determined for the first window 702 {X(W₁₋₁)}. Then the address 708 in the associative database equal to the first window transform is queried. The first entry at the address is a match indicator 710. There are three possible states for the match: no match, match (M) and qualified match (QM). When a match occurs this information is passed to a user (operating system) for further processing. When a no match state is found the window slides by one byte for example. This is shown as window W₂₋₁ 712. The subscript one means its the first size window (three byte size) and the subscript two means its the second window. Note the window has slid one byte to cover bytes B₁, B₂, B₃. Prior art techniques, such as hashing, would require determining a completely new transform for the bytes B₁, B₂, B₃. The present invention however uses advanced transform techniques for linear feedback shift registers that are explained in the United States patent entitled “Method and Apparatus for Generating a Transform”; U.S. Pat. No. 5,942,002; issued Aug. 24, 1999; assigned to the same assignee as the present application and incorporated herein by reference. These advanced transform techniques are also explained in detail with respect to FIGS. 7-11. Using these advanced techniques a transform (first byte icon) is calculated for a first byte of data (B₀). An icon shift function is performed on the first byte icon to form a shifted first byte icon. Note the shifted first byte icon is X(B₀ 0 0) in this case, where 0 0 represents two bytes of zeros. Note that this discussion also assumes that B₀ is the highest order byte.

The shifted first byte icon X(B₀ 0 0) is exclusive ORed with the first icon X(B₀ B₁ B₂) to form a seed icon X(B₁ B₂). Next a second icon X(B₁ B₂ B₃) is formed by transforming a new byte of data (B₃) onto the seed icon X(B₁ B₂). The process of transforming a new byte of data onto an existing transform is explained with respect to FIG. 9. In another embodiment, the seed icon is icon shifted to form a shifted seed icon X(B₁ B₂ 0). The shifted seed icon X(B₁ B₂ 0) is exclusive ORed with the icon for the new byte of data X(B₃) to form the second icon X(B₁ B₂ B₃). Now the second icon represents an address in the associative memory, so we can determine if there is a match for the data (B₁ B₂ B₃). This process then repeats for each new byte of data.

Using this process significantly reduces the processing time required to determine a match. Note that if the process is searching for several three bytes strings it requires the same number of steps as searching for a single three byte string of data. This is because each new data string just represents a different entry in the associative database 706. Whereas standard compare functions would have to perform a comparison for each data string being searched. Thus this invention is particularly helpful where numerous data strings need to be matched.

Often the data strings for which we are searching have differing lengths. In one embodiment this is handled by defining a separate window search size (e.g., W₂₋₁ 704). The two or more window sizes operate completely independently as described above. In another embodiment, the associative database 706 contains a qualified match for a first portion of each the data strings that are longer than the window length. Note in this case the window length (window size) is selected to be equal to the shortest data string being searched. When the process encounters a qualified match, two alternative implementations are possible. In one implementation, there is a pointer 714 associated with the qualified match. The pointer points to a second icon. The process determines an icon for a next window of data. When the icon for the next window of data matches the second icon a match has been found. Note that this technique can be extended for data strings that have sizes that are many times longer than the window size. However, this implementation is limited to data sizes that are multiples of the window size. This may be limiting in some situations. The second implementation has a match length 716 associated with the qualified match. The match length indicates the total length of the data string to be matched. Then an icon can be determined for the complete data string or for just that portion of the data string that does not have an icon. Using this icon the process can determine if there is match. Using these methods it is possible to handle searches for data strings having varying lengths. This method provides a significant improvement over comparison search techniques, that have to perform multiple comparisons on the same data when differing window lengths are involved.

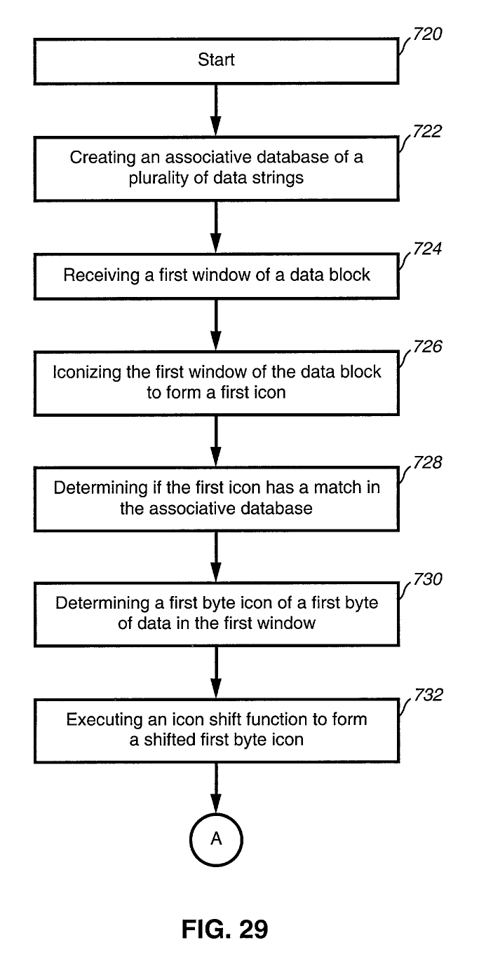

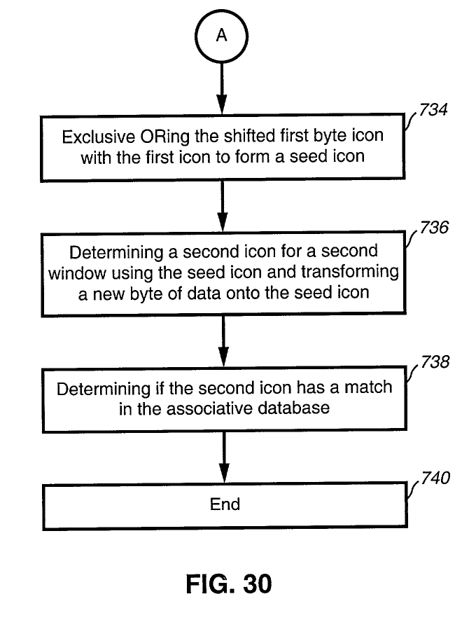

FIGS. 29 & 30 are a flow chart of the steps used in performing a sliding window search in accordance with one embodiment of the invention. The process starts, step 720, by creating an associative database of a plurality of data strings at step 722. A first window of a data block is received at step 724. The first window of the data block is iconized to form a first icon at step 726. Next it is determined if the first icon has a match in the associative database at step 728. A first byte icon is determined for the a first byte of data in the first window at step 730. An icon shift function is executed to form a first byte icon at step 732. The shifted first byte icon is exclusive ORed with the first icon to form a seed icon at step 734. A second icon is determined for a second window using the seed icon and transforming a new byte of data onto the seed icon at step 736. At step 738 it is determined if the second icon has a match in the associative database which ends the process at step 740. The process just repeats until the whole block of data has been analyzed for matches. Note the process described above assumes that second window has been shifted one byte from the first window. It will be apparent to those skilled in the art the process can be easily modified to work for shifts of one bit to many bytes. The process described above also assumes that the window is larger than a single byte. However, the process would work for a single byte.

In another embodiment, the process first determines if a single search window size is required. When only a single window search size is required an icon is determined for each of the plurality of data strings. When more than a single window search size is required, a minimum length search window is determined. Next an icon is calculated for each of a first plurality of data strings having a length equal to the minimum length, to form a plurality of first icons. The plurality of first icons are stored in the associative database. Next an icon is calculated for a first portion of each of a plurality of data strings, to form a plurality of second icons. The plurality of second icons are stored in the associative database. An icon is calculated for a second portion of each of the second plurality of data strings to form a plurality of third icons. The plurality of third icons are stored in the associative database. A pointer is stored with each of the second icons that points to the one of the plurality of third icons. Note that in one embodiment a match flag is stored at an address corresponding to the icons (first icons, second icons, third icons).

In another embodiment, when the process finds that the first icon is found in the associative database, it is determined if a pointer is stored with the first icon. When a pointer is not stored with the first icon, then a match has been found. When a pointer is stored with the first icon a next icon is determined. The next icon is the transform for the next non-overlapping window of the data block being searched. The next icon is compared to the an icon at the pointer location. When the next icon is the same as the icon at the pointer location a match has been found.

In another embodiment when the first icon is found in the associative database and includes a pointer, a second icon is determined. Next it is determined if the second icon has a matching the associative database. In another embodiment the second icon is determined using an icon append operation with a second portion to the first icon. The second portion is the next non-overlapping window of data in the data block being searched.

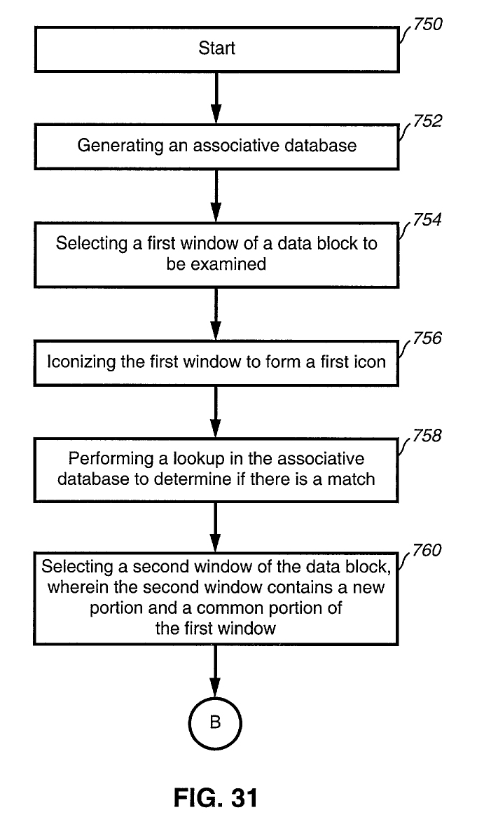

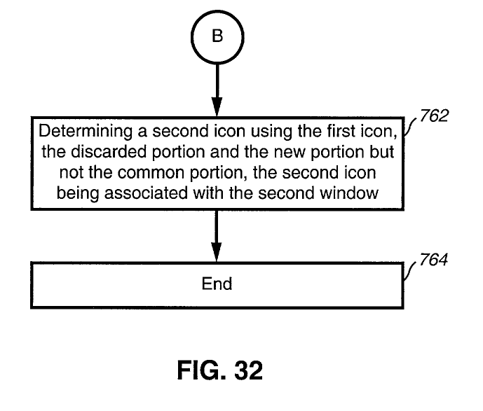

FIGS. 31 & 32 are a flow chart of the steps used in performing a sliding window search in accordance with another embodiment of the invention. The process starts, step 750, by generating an associative database at step 752. A first window of a data block is selected to be examined at step 754. The first window is iconized to form a first icon at step 756. A lookup in the associative database is performed to determine if there is a match at step 758. A second window of the data block is selected, wherein the second window contains a new portion and a common portion of the first window at step 760. A second icon is determined using the first icon, a discarded portion and the portion but not the common portion at step 762. The second icon is associated with the second window which ends the process at step 764. In one embodiment, this process is repeated until the complete data block has been examined. In another embodiment the process of forming an icon involves a linear feedback shift register operation. In another embodiment the linear feedback shift register operation is a cyclical redundancy code.

In another embodiment the process of forming the second icon includes determining a discarded icon for the discarded portion. Then an icon shift function is executed to form a shifted discarded icon. The shifted discarded icon is exclusive ORed with the first icon to form a seed icon. A new icon is determined for the new potion. The new icon is exclusive ORed with the seed icon to form the second icon.

In another embodiment the lookup process to determine if there is a match includes determining if the associative database indicates a match, a no match or a qualifier match. When a qualifier match is indicated, a next window icon for the next complete non-overlapping window of data is determined. Then it is determined if there is a pointer pointing from the first icon to the next window icon.

In another embodiment, when a qualifier match is indicated, a match length is determined. An extra portion is appended onto the first icon to form a second icon. Note the extra portion of the data plus the window of data that has been iconized is equal to the match length. Using the second icon it is determine if the associative database indicates a match.

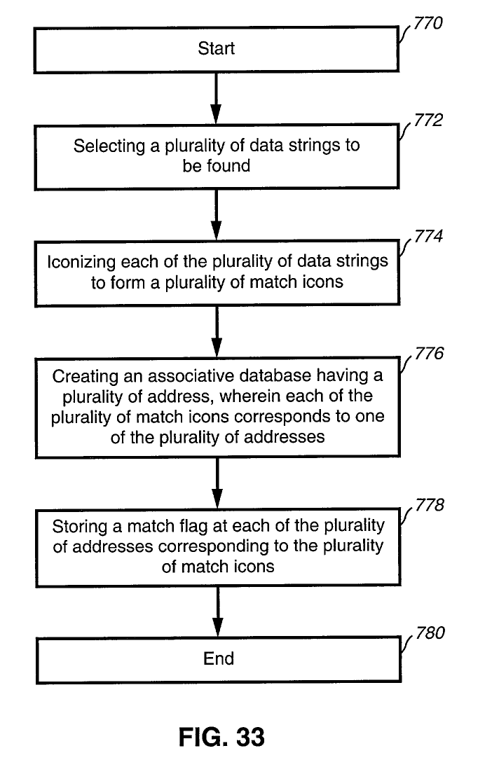

FIG. 33 is a flow chart of the steps used in performing a sliding window search in accordance with another embodiment of the invention. The process starts, step 770, by selecting a plurality of data strings to be found at step 772. The plurality of data strings are iconized to form a plurality of match icons at step 774. An associative database is created having a plurality of icons, wherein each of the match icons corresponds to one of the plurality of addresses at step 776. At step 778, a match flag is stored at each of the plurality of addresses corresponding to the plurality of match icons which ends the process at step 780. When the plurality of data strings do not all have a same length a plurality of shortest data strings are selected. A plurality of short icons associated with the shortest data strings are determined. The match indicator is stored in the associative database at the address associated with each of the short icons. A plurality of qualifier icons are determined for a first portion of a plurality of longer data strings. A qualifier flag is stored in the associative database for each of the qualifier icons. A match length indicator is stored with each of the qualifier icons in the associative database. An icon is determined for a first window of a data block, wherein the first window has a window length equal to a shortest length. A lookup is performed in the associative database to determine if there is a match flag or a qualifier flag. When there is a qualifier flag, the match length indicator is retrieved. A complete icon is determined for the portion of the data block equal to the match length. A lookup is performed to determine if there is a match flag associated with the complete icon.

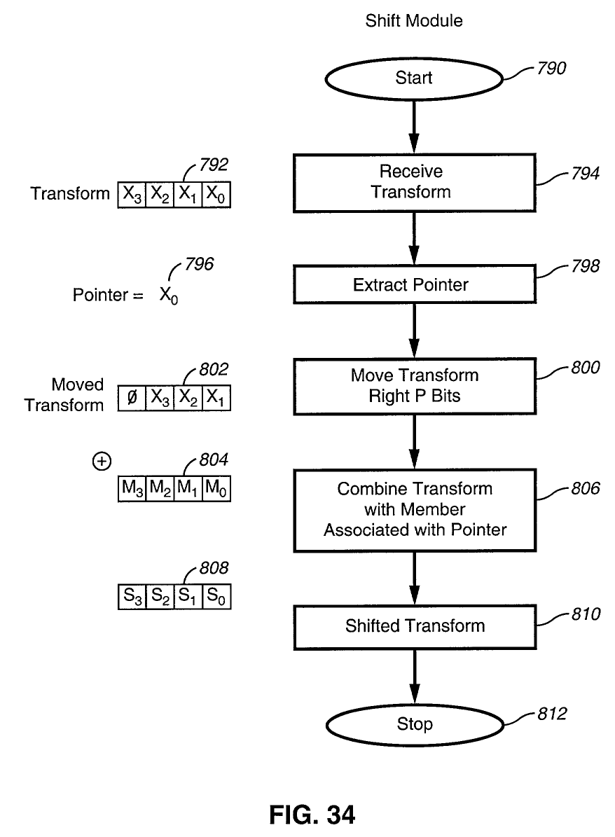

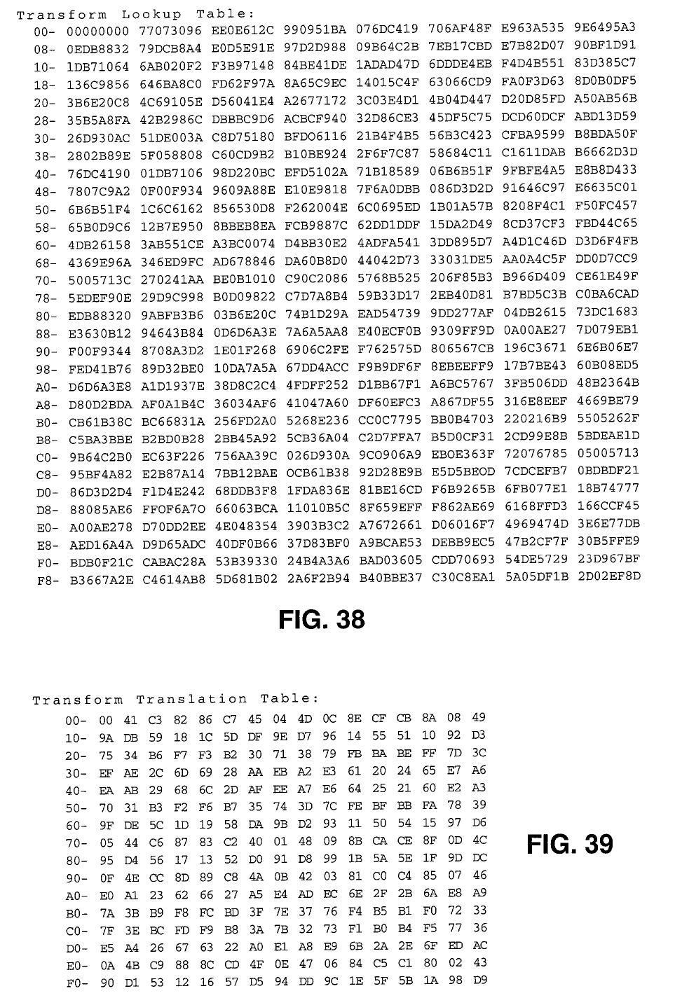

The following figures explain the “icon algebra” used in implementing the invention. FIG. 34 is a flow chart of the steps used in an icon shift function in accordance with one embodiment of the invention. The shift module determines the transform for a shifted message (i.e., “A0” or X^{Z}A(x)). Where X^{Z} means the function is shifted by z places (zeros) and A(x) is a polynomial function. The process starts, step 790, by receiving the transform 792 to be shifted at step 794. Next the a pointer 796 is extracted at step 798. The transform 792 is then moved right by the number of bits in the pointer 796, at step 800. This forms a moved transform 802. Note the words right and left are used for convenience and are based on the convention that the most significant bits are placed on the left. When a different convention is used, it is necessary to change the words right and left to fit the convention. Next the moved transform 802 is combined (i.e., XOR'ed) with a member 804 associated with the pointer 796, at step 806. The member associated with the pointer is found in a transform look table, like the one shown in FIG. 38. Note that this particular lookup table is for a CRC-32 polynomial code, however other polynomial codes can be used and they would have different lookup tables. This forms the shifted transform 808 at step 810, which ends the process at step 812. Note that if the reason for shifting a first transform is to generate a first-second transform then first transform must be shifted by the number of bits in a second data string. This is done by executing the shift module X times, where X is equal to the number of data bits in the second data string divided by the number of bits in the pointer. Note that another way to implement the shift module is to use a polynomial generator. The first transform 792 is placed in the intermediate remainder register. Next a number of logical zeros (nulls) equal to the number of data bits in second data string are processed.

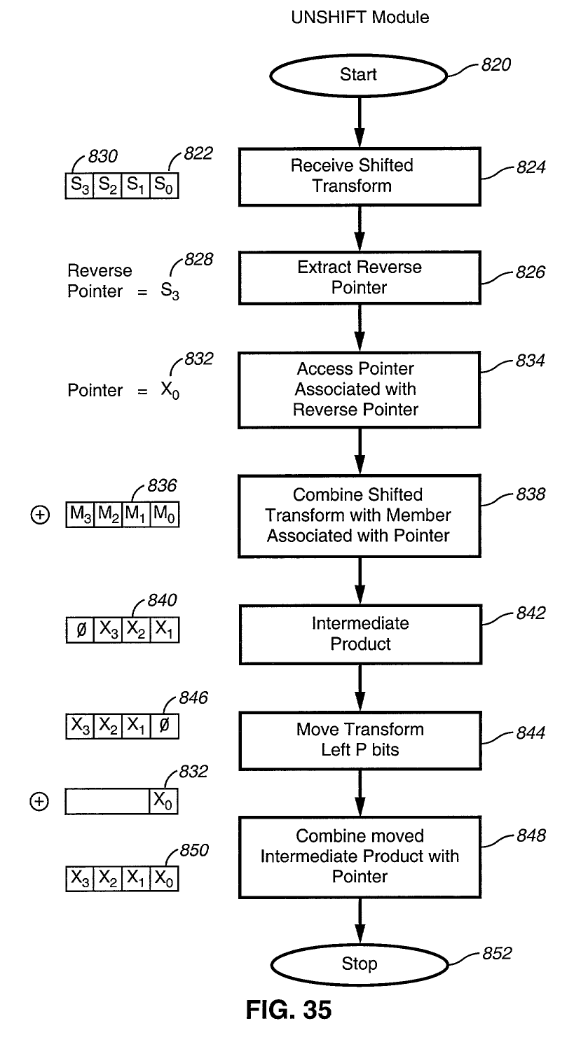

FIG. 35 is a flow chart of the steps used in an icon unshift function in accordance with one embodiment of the invention. An example of when this module is used is when the transform for the data string “AB” is combined with the transform for the data string “B”. This leaves the transform for the data string “A0” or X^{Z}A(x). It is necessary to “unshift” the transform to find the transform for the data string “A”. The process starts, step 820, by receiving the shifted transform 822, at step 824. At step 826 a reverse pointer 828 is extracted. The reverse pointer 828 is equal to the most significant portion 830 of the shifted transform 822. The reverse pointer 828 is associated with a pointer 832 in the reverse look up table (e.g., see FIG. 39) at step 834. Next, the member 836 associated with the pointer 832 in the table of FIG. 38 for example, is combined with the shifted transform at step 838. This produces an intermediate product 840, at step 842. At step 844 the intermediate product 840 is moved left to form a moved intermediate product 846. The moved intermediate product 846 is then combined with the pointer 832, at step 848, to form the transform 850, which ends the process, step 852. Note that if the number of bits in the “B” data string (z) is not equal to the number of bits in the pointer then the unshift module is executed X times, where X=z/(number of bits in pointer).

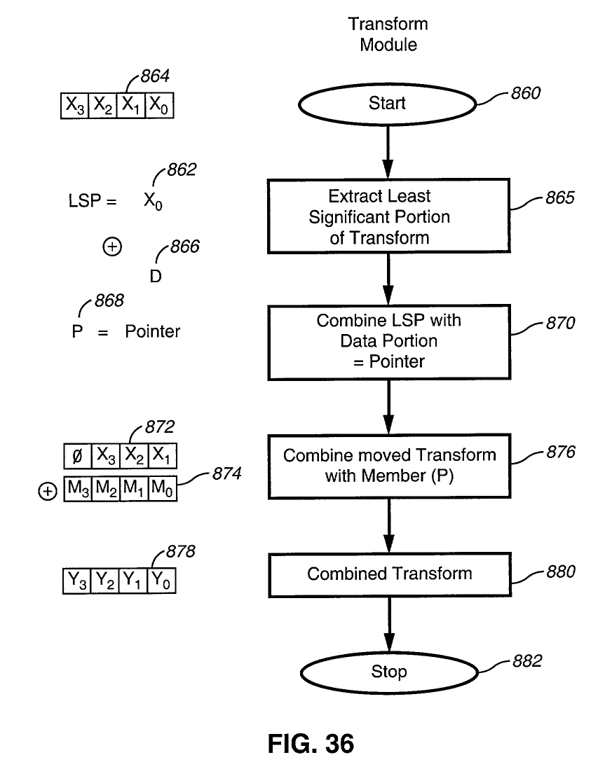

FIG. 36 is a flow chart of the steps used in a transform function in accordance with one embodiment of the invention. The transform module can determine the first-second transform for a first-second data string given the first transform and the second data string, without first converting the second data string to a second transform. The process starts, step 860, by extracting a least significant portion 862 of the first transform 864 at step 865. This is combined with the second data string 866 to form a pointer 868, at step 870. Next a moved first transform 872 is combined with a member 874 associated with the pointer in the look up table (e.g., FIG. 38), at step 876. A combined transform 878 is created at step 880 which ends the process, step 882. Note that if the pointer is one byte long then the transform module can only process one byte of data at a time. When the second data string is longer than one byte then the transform module is executed one data byte at a time until all the second data string has been executed. In another example assume that first transform is equal to all zeros (nulls), then the combined transform is just the transform for the second data string. In another embodiment the first transform could be a precondition and the resulting transform would be a precondition-second transform. In another example, assume a fourth transform for a fourth data string is desired. A first data portion (e.g., byte) of the fourth data string is extracted. This points to a member in the look up table. When the fourth data string contains more than the first data portion, the next data portion is extracted. The next data portion is combined with the least significant portion of the member to form a pointer. The member is then moved right by the number of bits in the next data portion to form a moved member. The moved member is combined with a second member associated with the pointer. This process is repeated until all the fourth data string is processed.

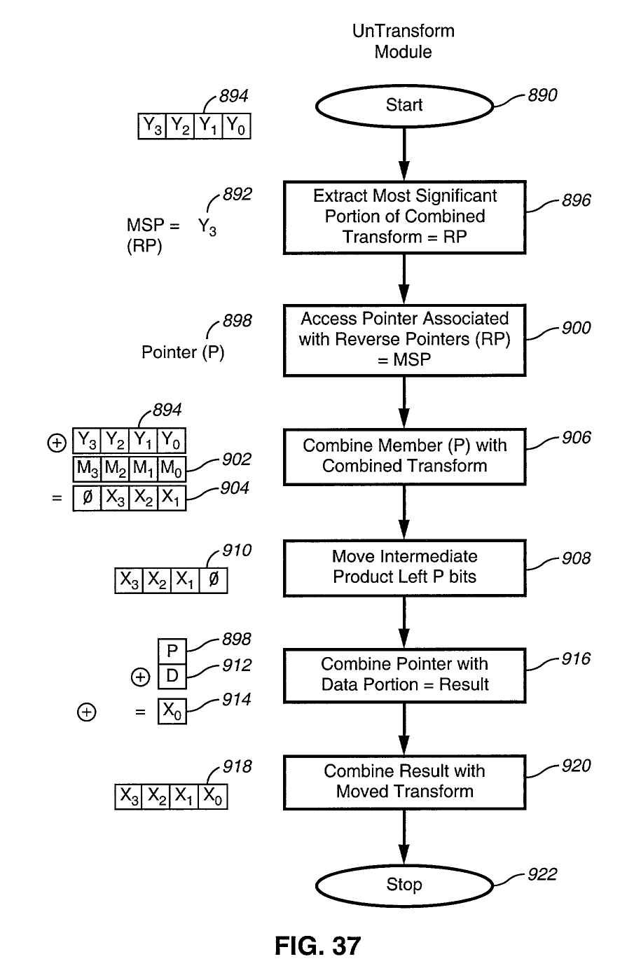

FIG. 37 is a flow chart of the steps used in an untransform function in accordance with one embodiment of the invention. The untransform module can determine the first transform for a first data string given the first-second transform and the second data string. The process starts, step 890. by extracting the most significant portion 892 of the first-second transform 894 at step 896. The most significant portion 892 is a reverse pointer that is associated with a pointer 898 in the reverse look-up table. The pointer is accessed at step 900. Next the first-second transform 894 is combined with a member 902 associated with the pointer to form an intermediate product 904 at step 906. The intermediate product is moved left by the number of bits in the pointer 898 at step 908. This forms a moved intermediate product 910. Next the pointer 898 is combined with the second data string 912 to form a result 914 at step 916. The result 914 is combined with the moved intermediate product 910 to form the first transform 918 at step 920, which ends the process at step 922. Again this module is repeated multiple times if the second data string is longer than the pointer.

Some examples of what the untransform module can do, include determining a second-third transform from a first-second-third transform and a first transform. The first transform is shifted by the number of data bits in the second-third data string. The shifted first transform is combined with the first-second-third transform to form the second-third transform. In another example, the transform generator could determine a first-second-third-fourth transform after receiving a fourth data string. In one example, the transform module would first calculate the fourth transform (using the transform module). Using the shift module the first-second-third transform would be shifted by the number of data bits in the forth data string. Then the shifted first-second-third transform is combined, using the combiner, with the fourth transform.

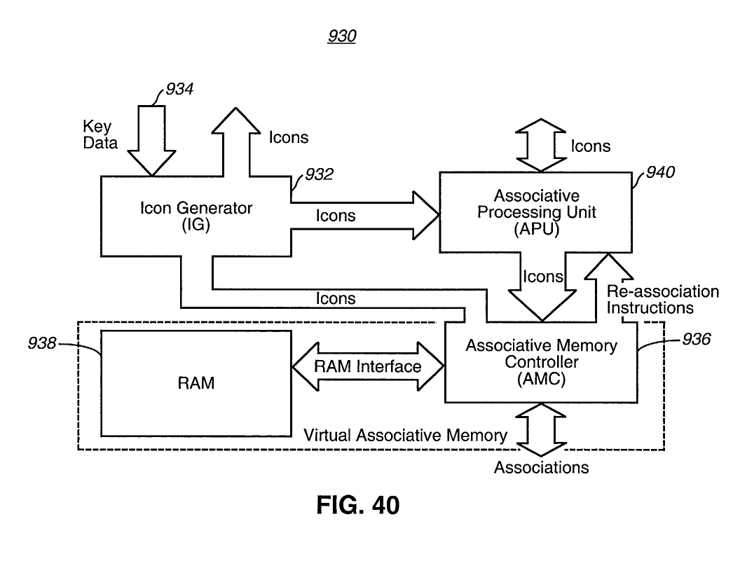

FIG. 40 is a block diagram of a system 930 for associative processing in accordance with one embodiment. The system 930 has an icon generator 932. The icon generator 932 has an input 934 connected to key data or input data that is converted to icons. The icon generator is connected to an associative memory controller 936. The associative memory controller (AMC) 936 receives icons from the icon generator 932. The associative memory controller 936 is connected to a RAM (random access memory; memory) 938. The AMC 936 and the RAM 938 form a virtual associative memory. The AMC 936 is connected to an associative processing unit 940. Note that the icon contains an address and a confirmer. The address is used to access the RAM 938 by the AMC 936. A confirmer from the address in the RAM is compared to the confirmer of the icon determine if a match has been found. For more information on the use of addresses and confirmers see U.S. Pat. No. 5,942,002 and U.S. Pat. No. 6,324,636 both assigned to the same assignee as the present application and hereby incorporated by reference.

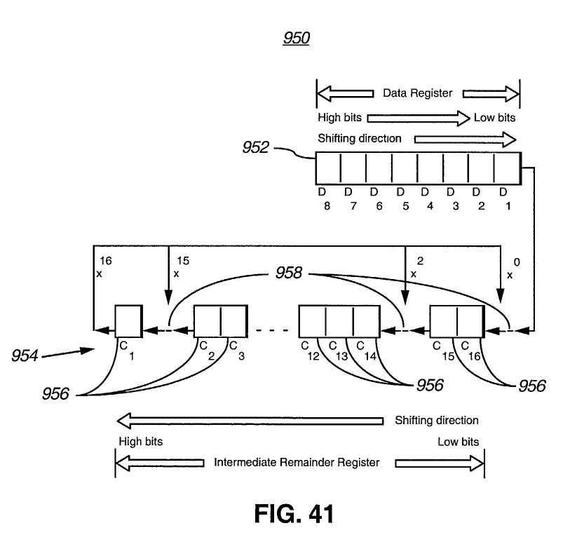

The icon generator may use a polynomial code to convert the key into an icon (or hash). The icon generator may also produce a plurality of lengths of icons. For more details on how the icon generator can produce multiple lengths of icons see US patent application entitled “Method of Forming a Hashing Code”, Ser. No. 09/672,754, filed on Sep. 28, 2000 assigned to the same assignee as the present application and hereby incorporated by reference. The hardware to produce the icon may be linear feedback shift register (See FIG. 41) as used to produce CRCs (cyclical redundancy code). Or may be a microprocessor running the algorithms shown in FIGS. 34-37. Note that FIG. 39 is a lookup table.

The associative memory controller 936 may be a microprocessor that controls the functions of the RAM, such as lookups, stores, deletes, and comparing of confirmers. This list is not meant to be exhaustive just exemplary. The associative processing unit 940 may be a microprocessor. In addition the APU 940 may include shift registers and exclusive OR arrays. Among the functions the APU 940 might perform are the shift module, unshift module and untransform module shown in FIGS. 34-37. In addition, any icon algebra that may be necessary. A formal treatment of the icon or linear algebra the APU 940 may perform is given in the appendix of the provisional patent application, having serial No. 60/240,427, entitled “Definition of Digital Pattern Processing” filed on Oct. 13, 2000, and assigned to the same assigned as the present application and providing priority for the present application. A less formal and less complete treatment of the icon algebra is discussed in U.S. Pat. No. 5,942,002. In one embodiment, a single microprocessor may perform the functions of the IG 932, AMC 936 and APU 940.

FIG. 41 is a linear feedback register 950 used to calculate an icon (CRC, polynomiela code) in accordance with one embodiment of the invention. The icon generator 950 has a data register (shift register) 952 and an intermediate remainder register 954. The specific generator of FIG. 41 is designed to calculate a cyclical redundancy code (CRC-16). The plurality of registers 956 in the intermediate remainder register 954 are strategically coupled by a plurality of exclusive OR's 958. The data bits are shifted out of the data register 952 and into the intermediate register 954. When the data bits have been completely shifted into the intermediate register 954, the intermediate register contains the CRC associated with the data bits. Transform generators have also been encoded in software.

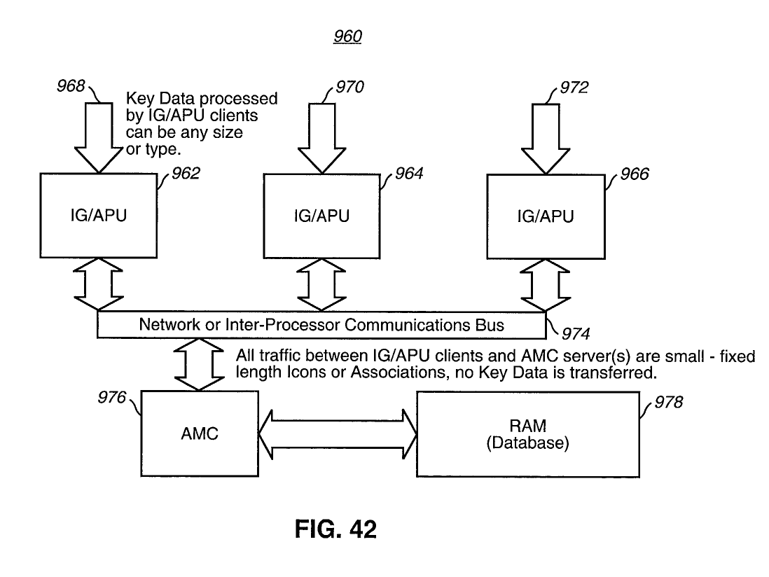

FIG. 42 is a block diagram of a system 960 for associative processing in accordance with one embodiment. The system 960 has multiple IG/APUs (icon generator/associative processing units; plurality of icon generators; plurality of associative processing units) 962, 964, 966. The IG/APUs 962, 964, 966 have an input connected to key data or input data streams 968, 970, 972. The IG/APUs are connected to a bus (network or inter-processor communication bus) 974. An AMC 976 is also connected to the bus 974. Generally, only icons of fixed length are passed over the bus 974. This significantly reduces the bus traffic and therefor the required bandwidth of the bus. The AMC 976 is connected to RAM 978 containing a database in one embodiment.

Thus there has been describe a system for associative processing that may be configured to perform any number of tasks including, associative databases, content scanning, packet accounting, extensible markup language database management systems and more.

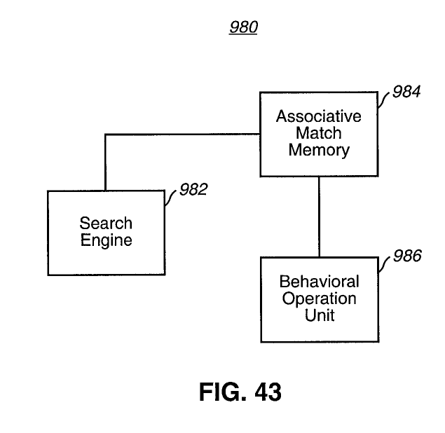

FIG. 43 is a block diagram of a system 980 for implementing behavioral operations in accordance with one embodiment of the invention. The system 980 has a search engine 982. The search engine 982 is connected to an associative match memory 984. A behavioral operation unit 986 is connected to the associative match memory 984. The operation of a search engine is explained with respect to FIGS. 28-33. The search engine can be implemented in software (firmware) or may be implemented in hardware. The behavioral operation unit 986 is implemented in memory and defines the behavior of the search engine 982.

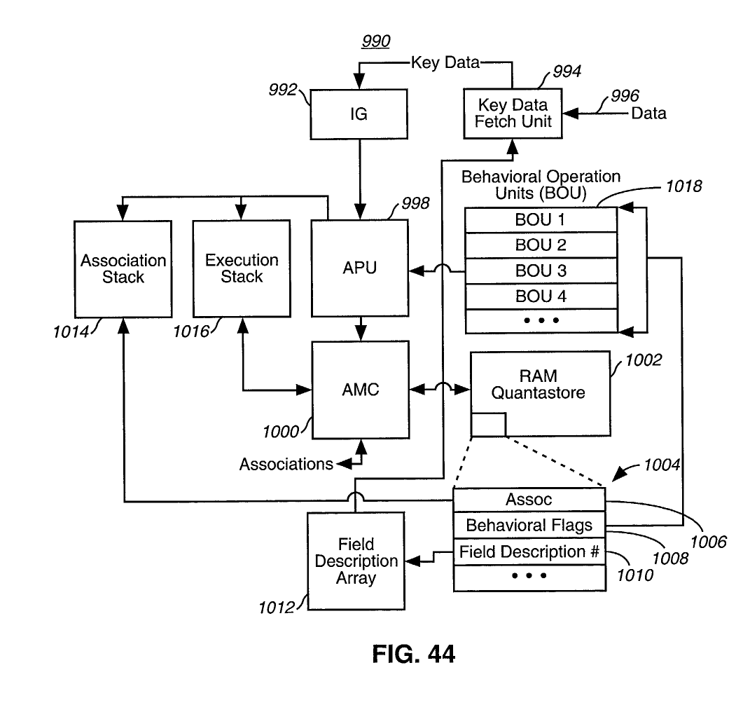

FIG. 44 is a block diagram of a system 990 for implementing behavioral operations in accordance with one embodiment of the invention. An icon generator 992 is connected to a key data fetch unit 994. The key data fetch unit 994 is connected to the input data 996. The icon generator 992 is connected to an associative processing unit (APU) 998. The APU 998 is connected to the associative memory controller (AMC) 1000. The AMC 1000 is connected to RAM 1002 which stores quanta 1004. The quanta 1004 may contain an association 1006, a behavioral flag (behavioral indicator) 1008, field description numbers 1010 and other information. The RAM 1002 is connected to the field descriptor array 1012. The RAM 1002 is connected to an association stack 1014. The AMC 1000 is connected to an execution stack 1016. The APU 998 is connected to the behavioral operation unit 368.

When the AMC 1000 locates an association 1004, one or more behavioral flags 1008 are encountered. The AMC 1000 receives the behavior flags 1008 and the field descriptor 1010 for processing. The APU 998 causes a new key data that is specified by the field data to be fetched by the key data fetch unit 994. The key data is then iconized by the IG 992. The APU 998 then executes the specific behavior specified by the behavioral flags 1008. When a quanta contains a particular behavior flag it is said to belong to the set of quantas that have that behavior or belongs to a behavioral set. Behaviors are generally accommodated (implemented) by the use of logical operators, state machines or both. When a behavior flag is set, the corresponding behavior operational unit is activated. Certain behavior combinations are supported, so multiple behavioral operation units can be activated at the same time. Some behaviors involve iconizing new key data using the quantas's field descriptor to locate the key data. A field descriptor consists of a list of byte offsets and a mask for “don't care” bits.

There are two stacks in the system 990. The association stack 1014 is used to hold possible association return values. For some operations, there is no way to determine which association to return until an association thread has been completed. For example, it is possible to have quanta that indicates it contains the return association (so it is pushed on the stack) unless a “better match” is found. The quanta would also contain a behavior flag that tells the APU how to go about finding a better match. If a better match is subsequently found, its return association value is pushed on the stack. Another behavior, for example, indicates than an exception to the current match condition may exist. If the exception is found, then the return association value at the bottom of the association stack is removed. When the thread is completed, the association return value at the bottom of the association stack is returned to the user.

The execution stack is used to optimize association thread performance. It allows thread execution to continue at a specified quanta in the event of a “dead end”. This happens, for example, if a match condition has multiple executions based on different field descriptors, and one of the exceptions has an exception to it (an exception to an exception). In this case, execution should continue at the first match conditions' quanta (not the preceding exceptions' quanta), in order to look for the next exception.

When an association thread is started, the user specifies a base set of field descriptors to begin with. As the association thread executes, other field descriptors are invoked by the field descriptor references contained in associated quantas.

The number of behaviors is not limited and may include almost any imaginable logical function. One of the behaviors is the association set. This indicates that the current quantas' association value should be pushed on to the association stack. Another behavior is the qualifier set. This indicates that additional key data should be iconized as specified in the referenced field descriptor and a subsequent lookup should be attempted. The possible effect of the next association is not known until it is found. Versions of the association set (M) and the qualifier set (QM) are explained with respect to FIGS. 28-33. Another behavior is the test set. This set contains an addition field for a score. As a thread is processed the association with the highest score is maintained. Any association that does not have a higher score is ignored. Another behavior is an exclusion set. This indicates that the quanta represents an exception, so the return association value at the bottom of the association stack is removed. Another behavior is the continuation set. This indicates that processing should continue.

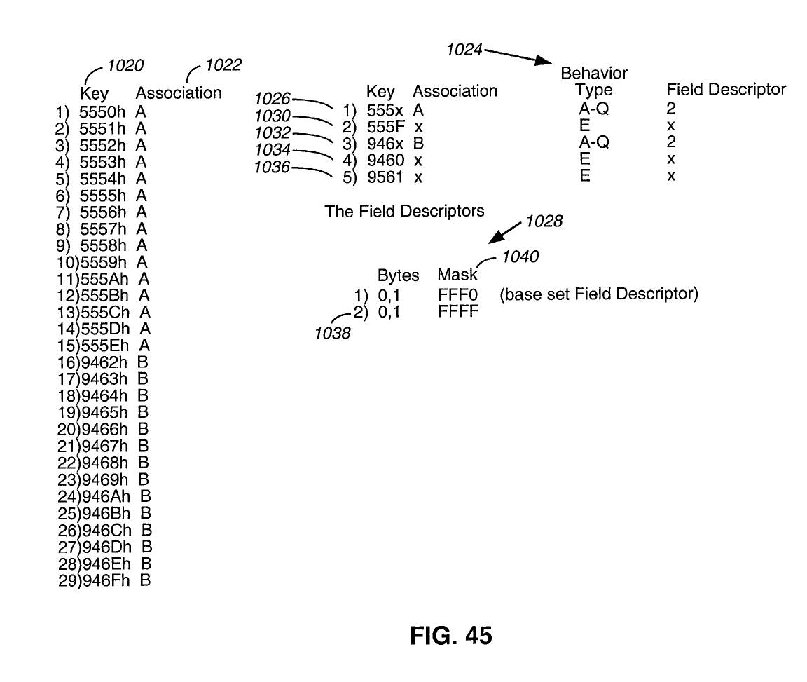

FIG. 45 is an example of a behavioral operation. Assume that a user wants to find the keys 1020 with the associations 1022. An associative memory with every entry could be created, however another alternative exists with behavioral sets. The keys 1020 and associations 1022 could be represented by the quantas 1024. Note that the “x” indicates a don't care. The first quanta 1026 indicates that the range of keys 5550-555F are potential matches. We know this because the behavior type (flag) is “A-Q”. The Q behavior tells us to investigate further using field descriptor “2”. The field descriptors 1028 are listed below. The next quanta 1030 shows that upon further investigation the key “555F” is excluded, but any of the other keys in the range will return the association “A”. Quantas 1032, 1034, 1036 are used to define when the association “B” is returned. Note that field descriptor “2” 1038 indicates an offset of “0” bytes or start at the zero byte and investigate to the first byte. The mask 1040 indicates “FFFF” which means all bits in the two bytes are to be processed. A “0” bit would indicate a don't care bit. While more complex searches may be created using the system the example shows the power to reduces the number of quantas that have to be created. In this example the number of quantas was reduced from twenty-nine to six and this is just part of the power of the behavioral operation system.

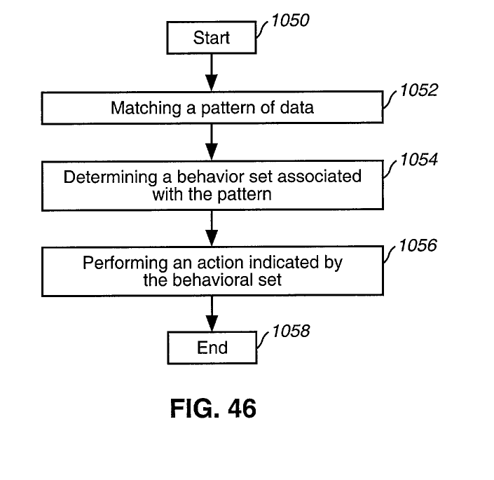

FIG. 46 is a flow chart of the steps used in a method of behavioral operation of a data document in accordance with one embodiment of the invention. The process starts, step 1050, by matching a pattern of data at step 1052. Next a behavior set associated with the pattern is determined at step 1054. At step 1056 an action indicted by the behavioral set is performed which ends the process at step 1058. In one embodiment the step of matching a pattern of data includes determining an icon for the pattern. Next an associative lookup using the icon is performed to determine if a match exists. In one embodiment, the action performed may include storing an association and acquiring an information connected to the association. An association usually points to a location in a store where additional information about the match may be found. For instance, the pattern might be a customer's name. The association would point to a location in the store where the customer's address may be found. In another embodiment, the action may be determining a new field of data to be examined.

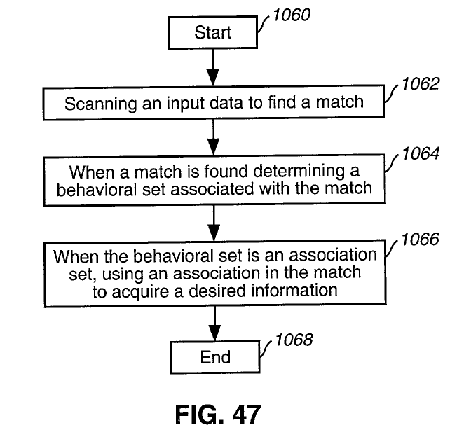

FIG. 47 is a flow chart of the steps used in a method of behavioral operation of a data document in accordance with one embodiment of the invention. The process starts, step 1060, by scanning an input data to find a match at step 1062. When a match is found, a behavioral set associated with the match is determined at step 1064. When the behavioral set is an association set at step 1066, an association in the match is used to acquire a desired information which ends the process at step 1068. In one embodiment, when the behavioral set is a qualifier set, a field descriptor pointer is acquired. A field descriptor pointed to by the field descriptor pointer is looked up. A field to be examined is determined next. A mask associated with the field descriptor is applied to the field to form a masked field. The masked field is transformed (iconized) to determine if a second match is found. When a second match is found, a second behavioral set is determined and the process is repeated.

In one embodiment when the behavioral set is a test set, a score is acquired with the match. The score is compared to a previous score. When the previous score is lower than the score, a test association is examined. In one embodiment, the test association is pushed onto the association stack. When a previous score is not lower than the score, the test association is ignored.

When the behavioral set is an exclusion set, a present association is removed from an association stack. When the behavioral set is a continuation set, a related association is returned and processing continues. When the behavioral set is a stack set, a search is continued for a duplicate.

Thus there has been described a system and method for performing very complex searches with minimal effort on the part of the user. The searches may be complex enough to include non-traditional actions as a result of the search. In other words, the action may include operations other than just returning information. For instance, the action might be to stop processing a request.

FIG. 48 is a block diagram of a universal information base system 1080 in accordance with one embodiment of the invention. The universal information base 1080 includes an associative information store 1082. The associative information store 1082 is coupled to a data input system (structured data input system) 1084. A search and behavioral operations system 1086 is coupled to the associative information system 1082. The search system 1086 has a result level 1088. The result level 1088 allows the user to specify the granularity they want returned as a result of an operation. For instance, the user can specify that result level be: a couplet, a line, a part of a document, a whole document or several documents. The associative information store 1082 in its simplest form is shown in FIG. 8. Other embodiment are shown in FIGS. 12 & 19. The data input system 1084 is also shown in FIG. 19. An embodiment of the search and behavioral operation system 1086 is shown in FIG. 44. Other embodiments are shown in FIGS. 42-43.

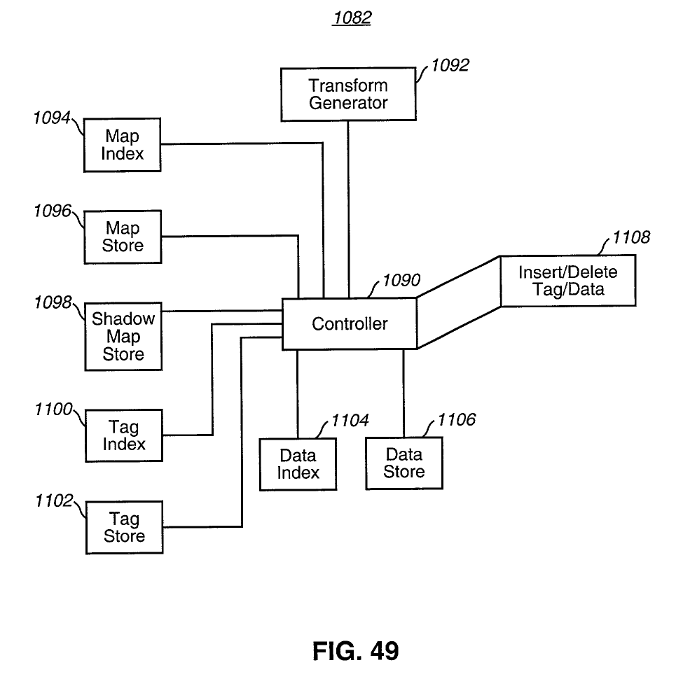

FIG. 49 is a block diagram of an associative information store 1082 in accordance with one embodiment of the invention. The associative information store 1082 has a controller 1090 coupled to a transform generator 1092. The transform generator 1092 is the same as the transform generators (icon generators) described previously. The controller 1090 is also coupled to a map index 1094, map store 1096 and shadow map store 1098. The shadow map store 1098 has the same basic structure as the map store 1096. The shadow map store 1098 is used to store intermediate results. For instance, a user may first do a search on “company>= RCA” and store this result in the shadow store. The user may then want to do a further search for “artist>= Gary More”. In addition, to allowing iterative searches the shadow store may be used to combine documents to form a larger document to be searched against. The controller 1090 is coupled to the tag index 1100, tag store 1102, data index 1104 and data store 1106. The controller 1090 has a function 1108 that allows inserting tags and data and deleting tags and data without rebuilding the store as described in FIGS. 4-7. This means that the associative information system is self constructing. In addition, the controller 1090 has function that allows it to restore the deleted tags or data. These functions allow the associative information store to manage data and metadata dynamically.

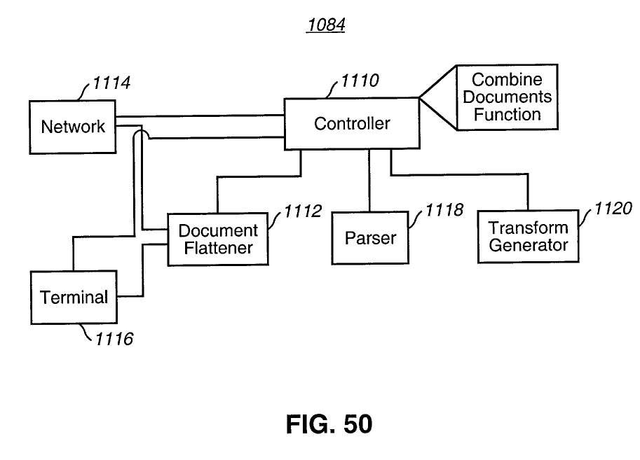

FIG. 50 is a block diagram of a data input system 1084 in accordance with one embodiment of the invention. The data input system 1084 has a controller 1110 coupled to a document flattener 1112. The function of the document flattener 1112 is described with respect to FIGS. 5-9. The document flattener 1112 may be coupled to a network 1114 or a terminal 1116. In one embodiment, the terminal 1116 has input forms that only require the user to enter data into the appropriate portion of the form. The form is automatically converted to the right format for the document flattener 1112. The document flattener 1112 is coupled to a parser 1118. The function of the parser is discussed with respect to FIGS. 5-9. The parser 1118 is coupled to a transform generator 1120.

By combining these elements the universal information store 1080 is able to provide functions not found in an database management system or structured (XML) data document system. For instance, the system allows users to easily specify behaviors or actions based on a matched pattern. A simple example would be a manager of record distribution company wants to let all their record stores know that all RCA records recorded before 1990 are on sale for a 50% discount. So the manager does a search for RCA and year before 1990. This is stored in a temporary document (shadow store). The price term is found for each of the records and altered to reflect the discount. This document is saved as a sale price document. Then the sales price document is forwarded to all their record stores.

Other features enabled by the system 1080 is complete extensibility of data and tags (metadata). This is inherent in how the associative information store 1082 and the data input system 1084 are designed. The system 1080 automatically indexes all data elements and all tags strings. Thus the system is very efficient at searching for items in the store. For incomplete data (metadata) strings, the search engine described in FIGS. 28-33 is very efficient. Especially when multiple strings of information at different lengths are being searched simultaneously. The system allows the user to retrieve context (metadata, tags) based on data. This is not possible with database systems. The system allows multiple layered searches and then an action to be taken based on these searches. The system also allows the user to specify what portion of a document he wants returned as a result of an operation. The system also provides numerous other advantages over prior art systems. These advantages are inherent in the structure of the system as described herein.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A universal information base system, comprising:
an associative information system;
a structured data input system coupled to the associative information system; and
a search engine coupled to the associative information system.

2. The system of claim 1, further including a behavioral operations system coupled to the search engine.

3. The system of claim 1, wherein the associative information system includes a map store, a dictionary and an index.

4. The system of claim 3, wherein the dictionary includes a tag dictionary and a data dictionary.

5. The system of claim 3, wherein the index includes a tag index, a map index and a data index.

6. The system of claim 3, further including a shadow map store.

7. The system of claim 1, wherein the structured data input system includes a document flattener coupled to a parser.

8. The system of claim 7, further including a transform generator coupled to the parser.

9. The system of claim 3, wherein the map store may contain more than one structured data document.

10. The system of claim 1, wherein the associative information store has an insert new tag function.

11. The system of claim 1, wherein the associative information store has a delete tag function.

12. The system of claim 2, wherein a search query includes a result level.

13. The system of claim 12, wherein the result level includes; a line, a record, a part of a document and a document selection.

14. A universal information base system comprising:
an associative information system;
a search engine coupled to the associative information system; and
a behavioral operations system coupled to the search engine.

15. The system of claim 14, further including a data input system coupled to the associative information store.

16. The system of claim 14, wherein the behavioral operations system includes a masking function.

17. The system of claim 14, wherein the behavioral operations system includes a behavior related to a match result.

18. A universal information base system comprising:
an associative information system;
a structured data input system coupled to the associative information system; and
a search and behavioral operations engine coupled to the associative information system.

19. The system of claim 18, wherein the associative information system has an insert new tag function.

20. The system of claim 18, wherein the structured data input system includes a combine documents function.

21. The system of claim 18, wherein the associative information system manages data and metadata dynamically.

22. The system of claim 18, wherein the associative information system contains heterogeneous information sets.

23. The system of claim 18, wherein the associative information system is self constructing.

24. The system of claim 18, wherein the associative information system automatically indexes every complete tag string.

25. The system of claim 18, wherein the associative information system automatically indexes every data entry.

26. The system of claim 18, wherein the associative information system automatically indexes every complete tag sting and associated data entery.

27. The system of claim 18, wherein the associative information system automatically indexes every alias.
